(19) United States
(12) Patent Application Publication
(10) Pub. No.: US 2009/0224432 A1
(43) Pub. Date: Sep. 10, 2009

(54) METHOD OF FORMING SPLIT ORIGINATING POINT ON OBJECT TO BE SPLIT, METHOD OF SPLITTING OBJECT TO BE SPLIT, AND METHOD OF PROCESSING OBJECT TO BE PROCESSED BY PULSE LASER BEAM

(76) Inventors: Syohei Nagatomo, Kyoto (JP); Noriyuki Kuriyama, Kyoto (JP); Junichi Masuo, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/721,001

(22) PCT Filed: Nov. 30, 2005
(86) PCT No.: PCT/JP05/21984

§ 371 Date: Jun. 6, 2007

(30) Foreign Application Priority Data
Dec. 8, 2004 (JP) 2004-355033
Jul. 22, 2005 (JP) 2005-212364

(51) Int. Cl. B29C 35/08

(52) U.S. Cl. 264/400

(57) ABSTRACT

Provided is a method of forming an originating point suitable for splitting a split object by irradiating a laser beam to the split object. With respect to a location for which splitting of the split object M is intended, a laser beam not having strong energy at which a scribe groove can be formed by ablation is irradiated in a state where the focus is defocused −20 μm to −30 μm, from the top surface of the split object M to the inside thereof. An affected region T having an elongated cross-section shape can be formed through rapid heating due to absorption and the following rapid cooling. At the time of break processing, a good break can be realized with the lowermost end portion of the affected region T as the originating point. Further, if once supplied in advance, to an intended split location, a material having a higher absorptance of the laser beam than the split object M in the wavelength range of the used laser beam, the absorption efficiency of the laser beam can be increased only at the location. Therefore, the formation of an affected region functioning as a split originating point can be carried out surely even by an irradiation of a laser beam of weak energy at which no absorption occurs by nature.

### TECHNICAL FIELD

The present invention relates to a microfabrication method using a laser beam and, in particular, a fabrication processing method suitable in splitting an object to be processed (a processed object).

### BACKGROUND ART

Fabrication processing, such as welding, cutoff, and punching, by using a laser beam such as YAG laser, have conventionally been used widely. In recent years, the apparatuses have also been known which are aimed at performing scribe processing or the like by means of, for example, pulse laser using triple harmonics of YAG, to a substrate material having a high hardness and brittleness such as sapphire, and one provided with a device such as a shorter wavelength LD (laser diode), an LED (light emitting diode) formed on the substrate material by using a wide band gap compound semiconductor thin film of GaN etc being also brittle (for example, refer to Japanese patent application laid-open No. 2004-114075 and Japanese patent application laid-open No. 2004-9139). In the patent document 1 and the patent document 2, the apparatuses have been disclosed which are able to perform machining and cutoff of a processed object by irradiating a laser beam to cause ablation at a position irradiated (a location to be processed).

It has conventionally been general that when splitting the above-mentioned substrate material or the like as an object in a large number of chips or dies (namely when breaking), firstly, a break groove (a scribe groove) as the originating point of a break is formed on the surface of a processed object (a split body), and thereafter break processing along the break groove is carried out to obtain the chips or the like. Consequently, even when using the laser beam as disclosed in Japanese patent application laid-open No. 2004-114075 and Japanese patent application laid-open No. 2004-9139, the irradiation condition should be determined regarding it as the essential requirement that the break groove can be formed by the ablation due to the laser beam. In the object to be split (the split object) that is a brittle material such as sapphire, SiC, or a stacked structure using these as a base material (an epitaxial substrate or a device), the energy required for forming the groove is large and hence high-power laser has been needed.

### DISCLOSURE OF THE INVENTION

However, the inventor of the present invention has found by repeating intensive experiment and observation that, when the originating point of splitting is formed by irradiating a laser beam, it is not the essential requirement to form the “scribe groove” by eliminating the material at the irradiation position of the split object by means of ablation.

The present invention relates to a method of forming an originating point for splitting in a split object by using a laser beam.

In accordance with the present invention, a method of forming an originating point for splitting in a split object includes an affected region forming step of forming an affected region after having been subjected to melting alteration in the split object by irradiating a pulse laser beam to an irradiated surface in the split object, while scanning the pulse laser in a predetermined scanning direction.

Thus, when splitting the split object, the lowermost end portion of the affected region formed by the melting alteration becomes the split originating point. This enables the split object to be split well.

Preferably, in this method, the pulse laser beam is irradiated under an irradiation condition where a portion of the split object to which the pulse laser beam has been irradiated does not disappear.

Thus, only if formed the affected region by the melting alteration, the split object can be split suitably without forming the scribe groove, thereby enabling suppression of the energy consumption during the pulse laser beam irradiation.

Preferably, the method further includes a preparatory step of performing a predetermined preparatory processing for causing absorption of the pulse laser beam to at least a part of an intended forming location of the originating point. The affected region forming step is an originating point forming step of forming the affected region that becomes the originating point by irradiating the pulse laser beam to the intended forming location after having been subjected to the preparatory processing. The originating point forming step is adapted to irradiate a pulse laser beam at energy of strength at which the originating point cannot be formed unless the preparatory step is carried out.

Thus, even when irradiating a laser beam of weak energy at which normally absorption does not occur sufficiently, absorption can occur surely at the location after having been subjected to the preparatory processing, and the absorptive state can be retained when scanning is made. It is therefore capable of forming the affected region functioning as the originating point of splitting by melting alteration under the irradiation of the laser beam of such weak energy.

Accordingly, an object of the present invention is to provide the method capable of surely forming the originating point for splitting in a split object, without irradiating a laser beam at high output.

### BRIEF DESCRIPTION OF DRAWINGS

FIG. 1 is a diagram showing the configuration of a laser processing apparatus 100 as an example of an apparatus for realizing the present invention;

FIG. 2 is a diagram showing illustratively the structure of the top surface of a stage 5;

FIG. 3 is a diagram showing a dust collection head 11;

FIG. 4 is a diagram showing schematically a defocus state;

FIG. 5 is a diagram as viewed by an optical microscope a surface of a split object M when a laser beam is irradiated, while changing a defocus value DF;

FIG. 6 is a diagram as viewed by the optical microscope a cross section perpendicular to a scanning direction when a laser beam is irradiated, while changing the defocus value DF;

FIG. 7 is a diagram of an enlarged image of a part of FIG. 6;

FIG. 8 is a diagram of an SEM image in the vicinity of a cross section when the defocus value DF is set to −20 μm;

FIG. 9 is a diagram as viewed by the optical microscope a break surface when a laser beam is irradiated, while changing the defocus value DF;

FIG. 10 is other diagram as viewed by the optical microscope the break surface when a laser beam is irradiated, while changing the defocus value DF;

FIG. 11 is a diagram showing the relationship between the defocus value DF and the depth of an affected region T;

FIG. 12 is a diagram showing schematically the actual state of irradiation of a laser beam LB at the time of defocus;

FIG. 13 is a diagram as viewed by the optical microscope a cross section perpendicular to the scanning direction of a split object when the pulse width is different;

FIG. 14 is a diagram showing schematically the configuration and the operation of an attenuator 20;

FIG. 15 is a diagram as viewed by the optical microscope a cross section of a split object M″ when a laser beam LB is irradiated to the split object M″, while changing the irradiation energy;

FIG. 16 is a diagram as viewed by the optical microscope the cross section of the split object M″ when a laser beam LB is irradiated to the split object M″, while changing the irradiation energy;

FIG. 17 is a diagram showing the relationship between the irradiation energy and an affected region T″ when the laser beam LB is irradiated to the split object M″, while changing the irradiation energy;

FIG. 18 is a diagram for explaining an example of the processing that realizes making sure of absorption of laser light according to a second embodiment;

FIG. 19 is a diagram showing a specific example using the processing that realizes making sure of absorption of laser light according to the second embodiment;

FIG. 20 is a diagram for explaining an example of the processing that realizes making sure of absorption of laser light according to a third embodiment;

FIG. 21 is a sectional view of a split object M in a surface having a processing line L1;

FIG. 22 is a diagram showing a specific example using the processing that realizes making sure of absorption of laser light according to the third embodiment;

FIG. 23 is a diagram illustrating the change with time in a peak value of pulse energy of a laser beam, when an affected region functioning as a split originating point is formed on a certain split object according to a fourth embodiment;

FIG. 24 is a diagram illustrating the change with time in the pulse repetition rate of a laser beam, when an affected region functioning as a split originating point is formed on a certain split object according to a modification; and

FIG. 25 is a diagram illustrating the change with time in the scanning speed of a laser beam when an affected region functioning as a split originating point is formed on a certain split object according to a modification.

### BEST MODE FOR CARRYING OUT THE INVENTION

### 1. First Embodiment

### Outline of Laser Processing Apparatus

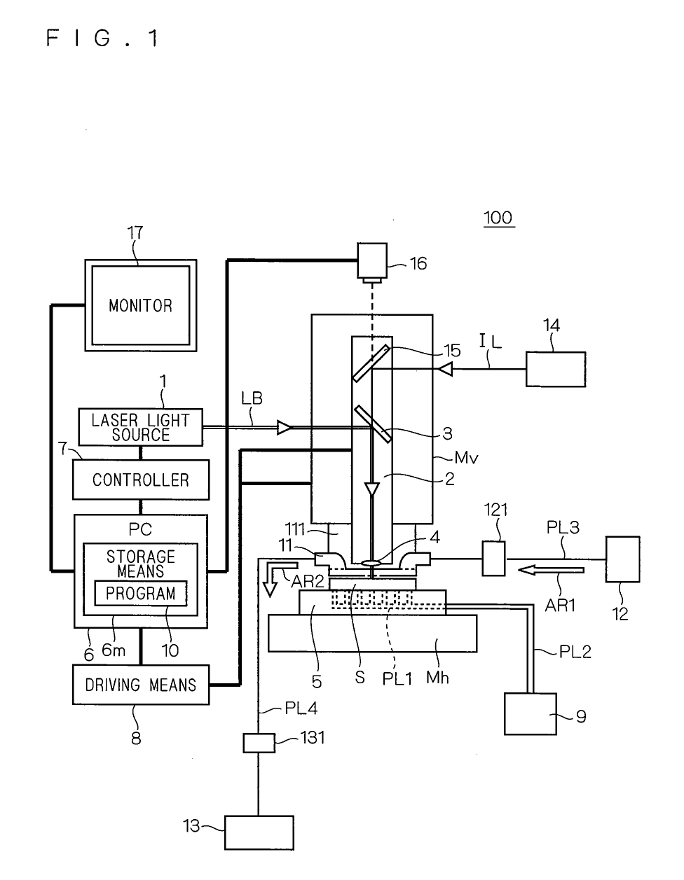

FIG. 1 is a diagram showing the configuration of a laser processing apparatus 100 as an example of the apparatus for realizing the present invention. The laser processing apparatus 100 is an apparatus which, after emitting a laser beam LB from a laser light source 1 so as to be reflected from a half mirror 3 provided within a lens barrel 2, collects the laser beam by a condenser lens 4 so as to be focused at a location to be processed (a processed location) of a processed object S put on a stage 5, and irradiates it to the process location thereby to realize the fabrication processing of the processed location, more specifically the formation of an affected region and ablation. The motion of the laser processing apparatus 100 can be realized by the execution of a program 10 stored in a storage means 6m of a computer 6 by the computer, in order to control the motions of components to be described later according to the program 10. As the computer 6, a general purpose personal computer (PC) can be used. The storage means 6m can be configured by, for example, a memory, a predetermined storage device, and the like, and it function to store various necessary data for operating the laser processing apparatus.

Although using Nd:YAG laser as the laser light source 1 is a preferred mode, it may be a mode of using Nd:YVO₄ laser or other solid state laser. Further, the laser light source 1 is preferably provided with a Q switch. The controls of the wavelength, the output power, pulse repetition rate, and pulse width of the laser beam LB can be realized by a controller 7 connected to the computer 6. When a predetermined setting signal is transmitted from the computer 6 to the controller 7, the controller 7 sets the irradiation condition of the laser beam LB based on the setting signal. In order to realize the method according to the present embodiment, the wavelength of the laser beam LB is preferably in a wavelength range of 150 nm to 563 nm. Especially when the Nd:YAG laser is used as the laser light source 1, it is a preferred mode to use the triple harmonics thereof (a wavelength of approximately 355 nm). The pulse repetition rate is preferably 10 kHz to 200 kHz, and the pulse width is suitably not less than 50 nsec. That is, the laser processing apparatus 100 according to the present embodiment performs fabrication processing by using UV repetition pulse laser. The laser beam LB is preferably irradiated after having been collected in a beam diameter of about 1 to 10 min by the condenser lens 4. In this case, the peak power density in the irradiation of the laser beam LB is approximately 1 GW/cm² or below.

The polarization state of a laser beam emitted from the laser light source 1 may be circular polarization or linear polarization. However, for linear polarization, in order that the polarization direction is substantially parallel to the scanning direction, the angle formed between the two is preferably set to within ±1°, from the viewpoint of the curve of processed cross section and the energy absorptance in a crystalline material to be processed .

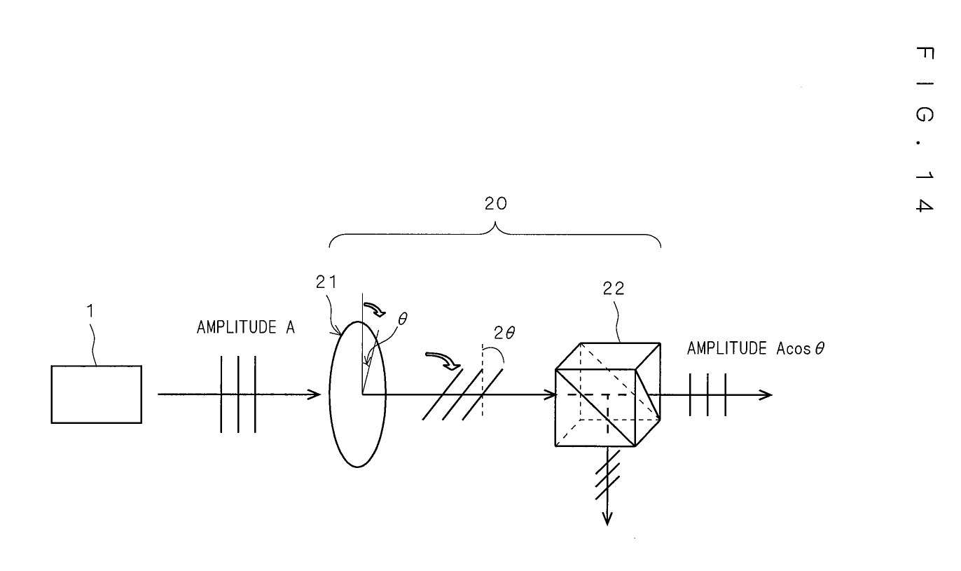

When the emitted light is linear polarization, the laser processing apparatus 100 is preferably provided with an attenuator 20. The attenuator 20, not being shown in FIG. 1, is disposed at a suitable position on an optical path of the laser beam LB, and functions to adjust the strength of the emitted laser beam LB. FIG. 14 is a diagram showing schematically the configuration and the operation of the attenuator 20. The attenuator 20 is provided with a half wave plate 21 and a polarization beam splitter 22. When the laser beam LB of linear polarization, which is emitted from the laser light source 1 and has a predetermined amplitude A, enters the half wave plate 21 at a certain azimuth angle θ, the laser beam LB with the amplitude A maintained is emitted from the half wave plate 21 at an angle of 2θ to the original vibration direction, and then enters the polarization beam splitter 22. The polarization beam splitter 22 is arranged so that it splits the laser beam LB in the original vibration direction and a vibration direction perpendicular thereto, and only the former can be emitted to the processed object S. The amplitude of the emitted light at this time is A cos 2θ. With the arrangement of the half wave plate 21 so that it can change the azimuth angle θ, the adjustment of the strength of the laser beam LB irradiated to the processed object S can be realized by changing the azimuth angle θ. Since the linear polarization can be converted to the circular polarization by further providing a quarter wave plate ahead of the polarization beam splitter 22, the energy adjustment by the attenuator 20 can be made even when irradiating a laser beam of circular polarization.

The focusing of laser in the laser processing apparatus 100 can be realized by fixing the processed object S to the stage 5, and moving the lens barrel 2 in the height direction (the z-axis direction). The movement of the lens barrel 2 (the adjustment of height) can be realized by driving a vertical movement mechanism Mv and the lens barrel 2 provided in the vertical movement mechanism Mv so as to be movable up and down, by driving means 8 connected to the computer 6. This enables a coarse motion attained by driving the vertical movement mechanism Mv, and a fine motion attained by moving up and down the lens barrel 2 to the vertical movement mechanism Mv, and a speedy and high-precision focusing motion can be realized by the response of the driving means 8 to the driving signal from the computer 6.

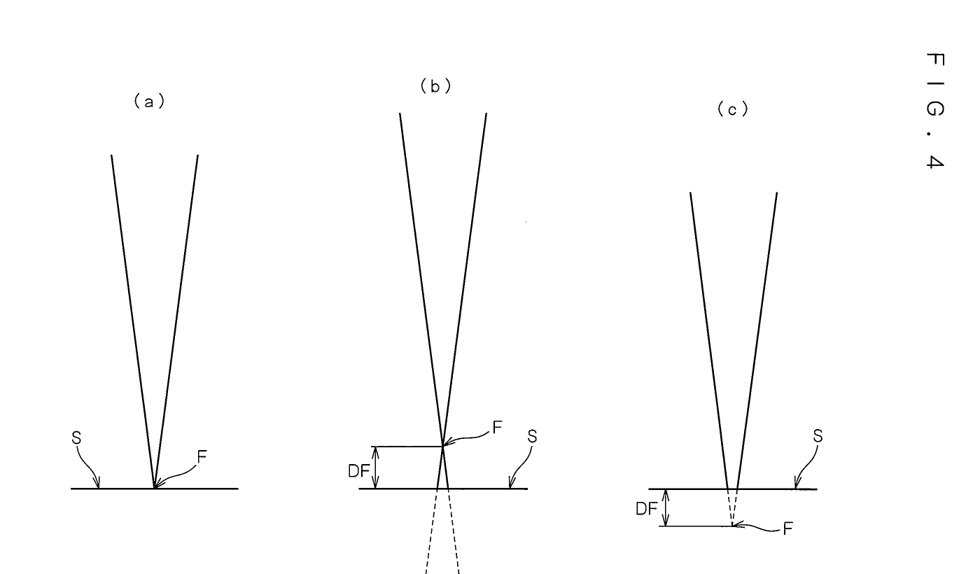

It is noted that the laser processing apparatus 100 can irradiate as needed the laser beam LB in a defocus state where the focusing position is intentionally moved from the surface of the processed object S. FIG. 4 is a diagram showing schematically the defocus state. Although the laser beam LB is actually irradiated so as to have a predetermined beam diameter as a focal position, a focus F will be described as a point in FIG. 4, for sake of simplicity.

First, FIG. 4(a) shows the case where the focus F of the laser beam LB matches the surface of the processed object S. Defocusing can be realized by moving up and down the focus F a predetermined distance by matching the focus F with the surface of the processed object S as in FIG. 4(a), and then driving the vertical movement mechanism Mv or moving up and down the lens barrel 2. FIGS. 4(b) and (c) show the states where the focus F is moved up and down from the surface of the processed object S, namely defocus states, respectively. The offset value of the focus F from the surface of the processed object S at this time shall be referred to as a defocus value DF. The focus value DF will have a positive value when the focus F is above the processed object S, as in FIG. 4(b), and have a negative value when the focus F is below the processed object S, as in FIG. 4(c).

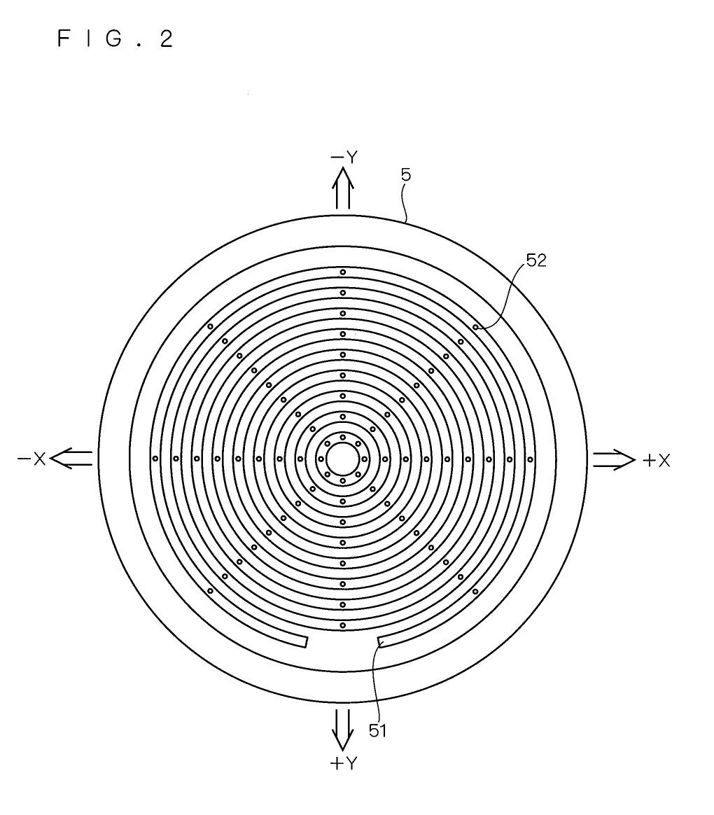

FIG. 2 is a diagram showing illustratively the structure of the top surface of the stage 5. A plurality of suction grooves 51 are disposed in the form of a concentric circle on the top surface of the stage 5 shown in FIG. 2, and suction holes 52 are disposed radially in the suction grooves 51. By operating suction means 9 such as a suction pump connected to the suction holes 52 and piping PL1 and PL2, in a state where the processed object S is put on the top surface of the stage 5, suction force acts along the suction grooves 51 with respect to the processed object S, and the processed object S can therefore be fixed to the stage 5. In cases where the processed object S is split after fabrication processing, such as a semiconductor substrate or the like, it can be fixed through a predetermined expand tape. Thus, even for a processed object having warp, such as a processed object in which a compound semiconductor is epitaxially grown on a sapphire substrate, fabrication processing can be made if a different in irregularity due to the warp is about several μm to several tens μm, falling within the focusing position tolerance of the laser beam LB.

Further, the stage 5 can be formed of a substantially transparent material, such as quartz, sapphire, and crystal, with respect to the wavelength of the laser beam LB. Consequently, the laser beam LB passing through the processed object, and the laser beam irradiated anywhere other than the object to be processed (These are referred to as “excessive laser beam.”) cannot be absorbed by the surface of the stage 5. This eliminates the possibility that the stage 5 may be damaged by the excessive laser beam.

Furthermore, the stage 5 is disposed on a horizontal movement mechanism Mh. The horizontal movement Mh can be driven horizontally in the XY biaxial directions by the motion of the driving means 8. In the present embodiment, these X-axis and Y-axis are coordinate axes determined as a reference coordinate, with a certain machine datum position as the origin, and a plane defined by these two axes shall be referred to as a reference coordinate plane.

Additionally, with regard to the stage 5, the rotation (θ rotation) motion in a horizontal plane about a predetermined rotation axis can also be realized independently of the horizontal drive. In the present embodiment, xy coordinate axes shall be given by using a certain position in the reference coordinate plane as the origin, and the clockwise direction with the x-axis positive direction as the position of 0° may be taken to be positive direction of the angle θ. Further, the above-mentioned rotational axis direction may be taken to be the z-axis. That is, the xyz coordinate system can be determined an perpendicular coordinate system relatively fixed to the reference coordinate.

By the driving means 8 driving the horizontal movement mechanism Mh in response to a driving signal from the computer 6, the alignment of the processed object S can be realized, and a predetermined processed location can be moved to the irradiation position of the laser beam LB. During fabrication processing, the laser beam LB can be scanned relatively to the processed object S.

On the other hand, by-products of processing such as particles which may be caused, when carrying out fabrication processing, by the fact that the material of the processed location melts or vaporizes and thereafter re-solidifies or scatters in the solid state, can be a factor of contaminating the surface of the processed object S or the condenser lens or the like. Hence, in the laser processing apparatus 100 according to the present embodiment, for the purpose of eliminating the above-mentioned by-products of processing, the dust collection head 11 is supported by a supporter 111, and annexed to the lowermost part of the vertical movement mechanism Mv.

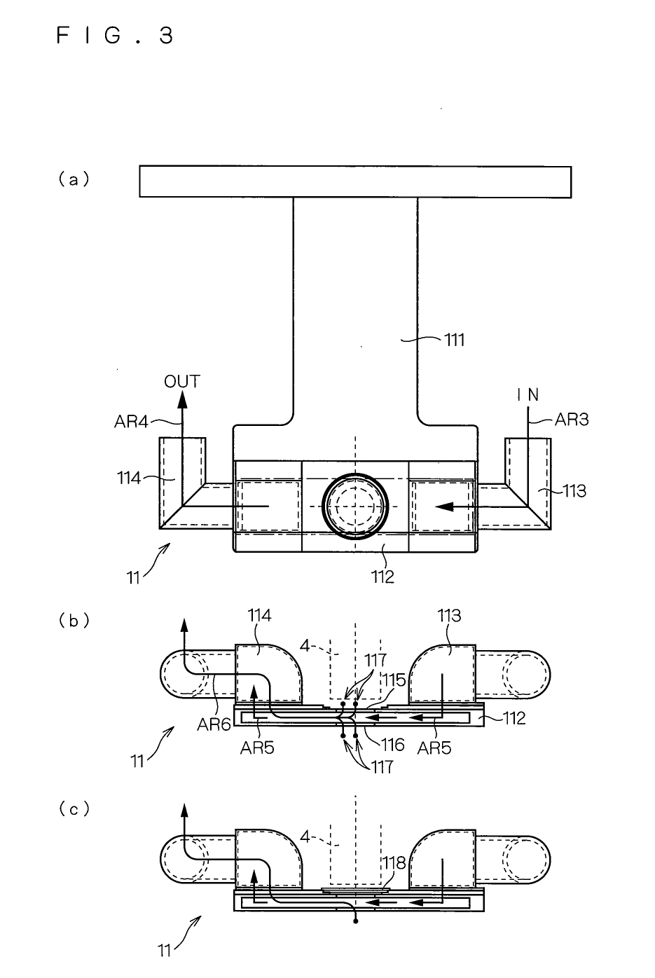

FIG. 3 is a diagram showing the dust collecting head 11. FIG. 3(a) is a top view of the dust collecting head 11 and the supporter 111; and FIGS. 3(b) and 3(c) are side views of the dust collecting head 11. The dust collecting head 11 consists of a dust collecting part 112 having a flat and hollow structure, and an inlet port 113 and an exhaust port 114, each of which is disposed at the end portion and the upper part of the dust collecting part 112 and communicated inside the dust collecting part 112.

The dust collecting part 112 is disposed so as to locate in between the processed object S and the condenser lens 4 provided at the lowermost part of the lens barrel 2. In the dust collecting part 112, an upper opening 115 and a lower opening 116 are disposed above and below the position that becomes the center when viewed from the top surface (FIG. 3(b)). Since these upper opening 115 and lower opening 116 are disposed so that the center thereof exactly matches the optical axis of the laser beam LB, there is no likelihood that the course of the laser beam LB will be intercepted by the dust collecting head 11. Since the dust collecting head 11 is annexed to the vertical movement mechanism Mv, the vertical movement mechanism Mv moves up and down, and the dust collecting head 11, namely the dust collecting part 112 also moves up and down. However, since the lens barrel 2 can move up and down singly as described above, the focusing position of the laser beam LB cannot be limited by the arrangement of the dust collecting part 112.

The inlet port 113 is connected by piping PL3 to inert gas supplying means 12 equipped as the utility of a factory where the laser processing apparatus 100 is installed, or the like. The exhaust port 114 is connected by piping PL4 to exhaust means 13 that can be realized by an exhaust pump or the like. Filters 121 and 131 are interposed in the piping PL3 and PL4, respectively.

The inert gas supplying means 12 is capable of continuously supplying an inert gas (for example, nitrogen gas). As shown by the arrow AR1 (FIG. 1), the inert gas supplied from the inert gas supplying means 12 is supplied to the dust collecting part 112 from the inlet port 113 in the dust collecting head 11 as indicated by the arrow AR3 (FIG. 1), and then exhausted via the exhaust port 114 by the exhaust motion of the exhaust means 13 as shown by the arrows AR2 (FIG. 1) and AR4. Therefore, in the inside of the dust collecting part 112, the inert gas flow directed from the inlet port 113 to the exhaust port 114 occurs as shown by the arrow AR5. Along with this, pulling pressure is generated in the vicinity of the upper opening 115, the lower opening 116 or the like, so that particles 117 existing in the neighborhood thereof can be drawn into the dust collecting part 112 and then exhausted together with the inert gas from the exhaust port 114, as shown by the arrow AR6. By this mode, it is avoidable that the by-products of processing such as the particles generated by laser processing are adhered to the surface of the processed object S and the condenser lens 4, thereby preventing a drop in the efficiency of processing. That is, the inert gas acts as assist gas during fabrication processing.

Alternatively, as shown in FIG. 3(c), the adhesion of the particles to the condenser lens 4 may be prevented by employing the mode where the upper opening 115 is covered detachably by a cover plate 118 made up of a transparent material to the laser beam LB, such as quartz.

Returning to FIG. 1, a description will be made of components provided in the laser processing apparatus 100 which are for performing the alignment of the processed object S and the positioning of the processed location, and for understanding the circumstances during fabrication processing. With the aim of these, the laser processing apparatus 100 has an illuminating light source 14, a half mirror 15 disposed in the lens barrel 2 in order to reflect and irradiate an illuminating light IL emitted from the illuminating light source 14 to the processed object S, a CCD camera 16 disposed above the lens barrel 2 which takes an image of the surface of the processed object S, and a monitor 17 for displaying a real time observation image (a monitor image) captured by the CCD camera 16, and an image (a stored image) stored in the storage means 6m as image data, as well as various processing menus and the like. The CCD camera 16 and the monitor 17 are connected to the computer 6 and controlled by the computer 6. By having these, it is possible to perform the alignment of the processed object S and the positioning of the processed location, while confirming the situation of the surface of the processed object S by the monitor 17, or find out the situation of the surface of the processed object during fabrication processing.

<Formation of Split Originating Point by Melting Alteration Method>

A description will next be made of the processing for forming a break originating point (a split originating point) in a split object by the laser processing apparatus 100. In the present embodiment, a processed object, which is subjected to splitting in a later break process, is particularly referred to as a “split object.” The following description will be made taking as an example the case where the triple harmonics of a Nd:YAG laser (the wavelength of approximately 355 nm) is used as the laser light source 1, and a single crystal sapphire is used as the split object M. Without limiting the split object M to this, it may be a single crystal SiC, a layered product where on a mono-crystalline substrate composed of these or other kind, a III-V nitride semiconductor or other single crystal is formed, or a high brittle material including polycrystalline and a layered product using this.

First, a description will be made of the case where the pulse repetition rate of the laser beam LB is set to 50 kHz, the pulse width is set to 75 nsec, the irradiation energy is set to 0.9 W, the scanning speed is set to 20 mm/sec, and the beam diameter at the focus F is set to 2 μm, and the laser beam LB is irradiated linearly a plurality of times with a predetermined locational spacing with respect to the split object M, by scanning the laser beam LB a plurality of times with respect to the top of the split object M so that individual scanning lines are parallel to each other. The irradiation condition of the laser beam LB in this case is referred to as “first irradiation condition.” Under the first irradiation condition, the irradiation of a laser beam is carried out so that the irradiation position per unit pulse is overlapped. In the following, the irradiation of the laser beam is carried out in such an overlap state unless otherwise noted in the following. At the time of individual irradiations, different defocus values was set in the range of 20 μm to −50 μm.

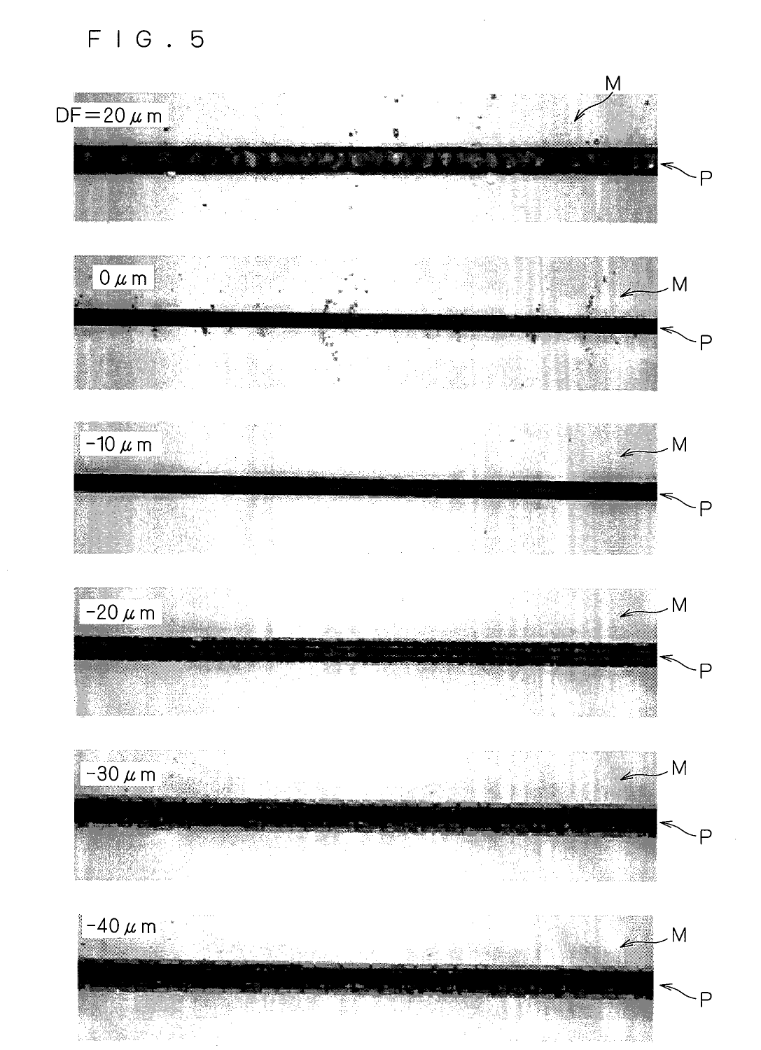

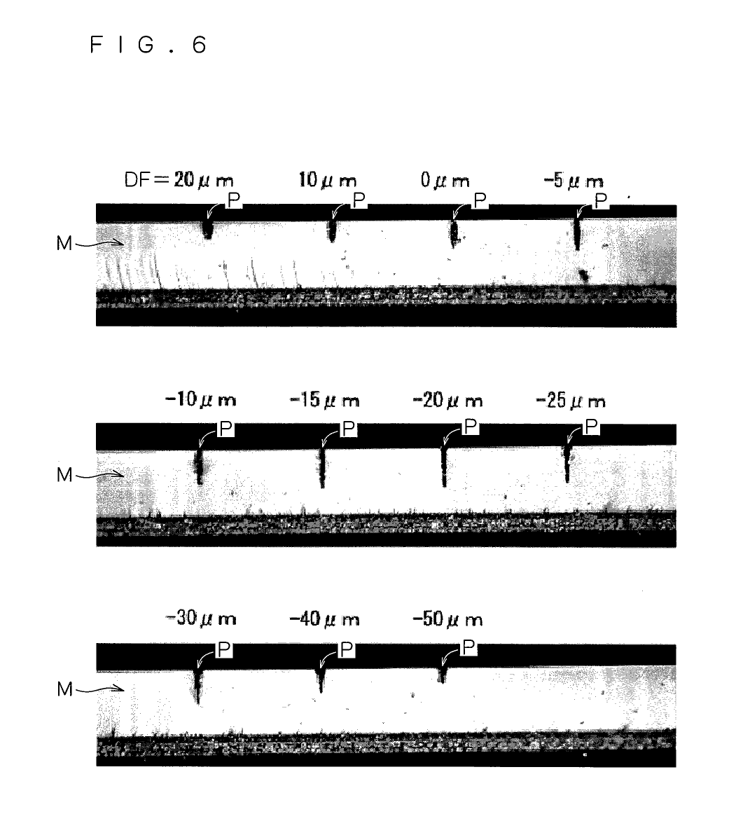

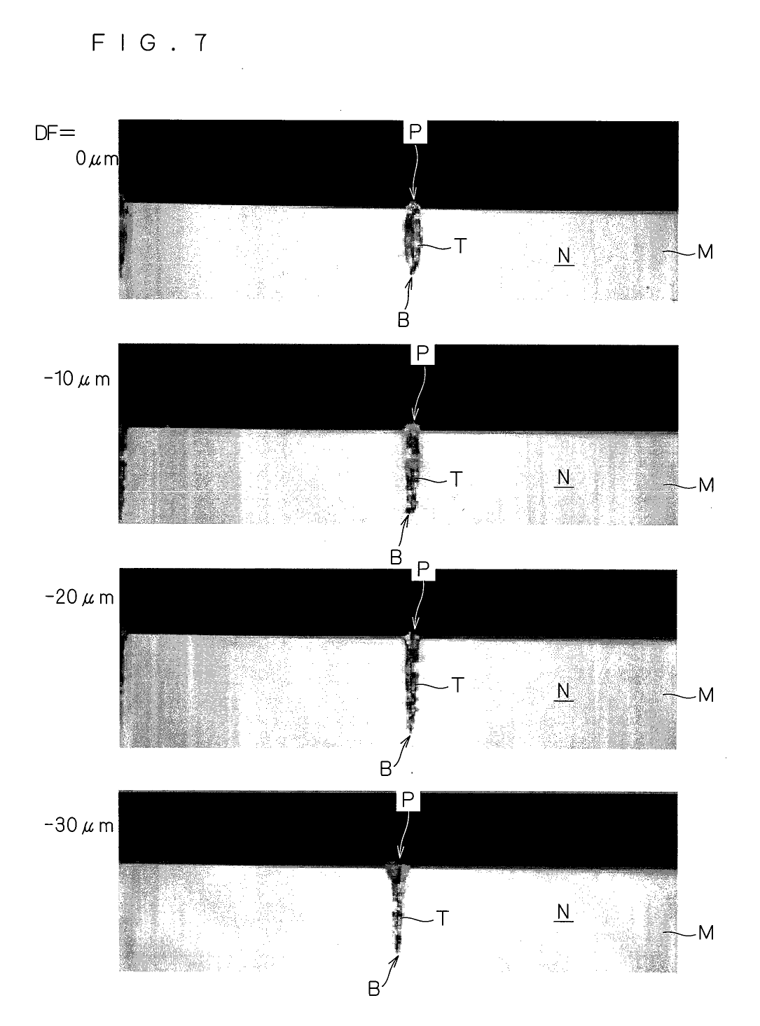

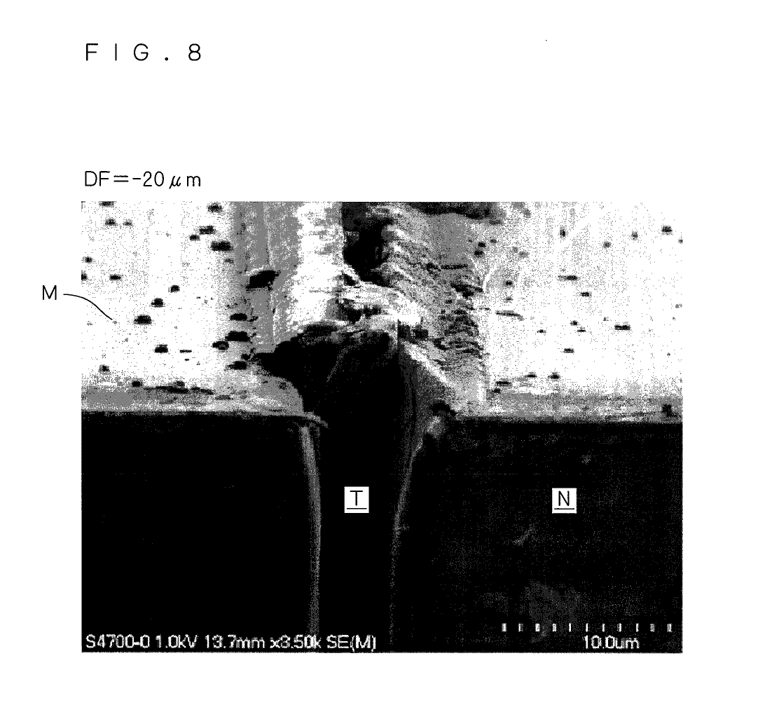

FIG. 5 shows the optical microscope images of the surfaces of split objects with regard to some defocus values DF in the above-mentioned case. FIG. 6 shows optical microscope images of the cross section perpendicular to the scanning direction. FIG. 7 shows enlarged images in the cases of some defocus values DF from among these. FIG. 8 shows an SEM image in the vicinity of a cross section when the defocus value DF is set to −20 μm.

Referring to FIG. 5 and FIG. 6, the split object M can be observed as substantially light white, whereas the irradiation position P of the laser beam LB is black, and a groove seems to be formed at the irradiation position P. However, in accordance with the images shown in FIG. 7 and FIG. 8, no groove is formed at the irradiation position P, but it can be confirmed that an affected region T exists, having a different crystal state from the surroundings thereof due to the irradiation of the laser beam LB. Especially in FIG. 8, it can be clearly confirmed that the affected region T has a swell toward the surface side. In the cases of other defocus values DF, the same situation as in FIG. 7 and FIG. 8 has been confirmed tough its illustration is omitted. Hereinafter, the region other than the affected region T in the split object M is referred to as a normal region N. It can also be confirmed that the affected region T is formed substantially vertical to the top and bottom surfaces of the split object M, and the lowermost end portion B of the affected region T is immediately below the irradiation position P.

The fact that no groove formation due to disappearance of the material occurs in spite of the laser beam irradiation means that the laser beam of lower energy density than that capable of causing ablation has been irradiated in the irradiation of the laser beam LB under the first irradiation condition. Hence, the first irradiation condition is an example of the conditions of irradiating the laser beam of such weak energy.

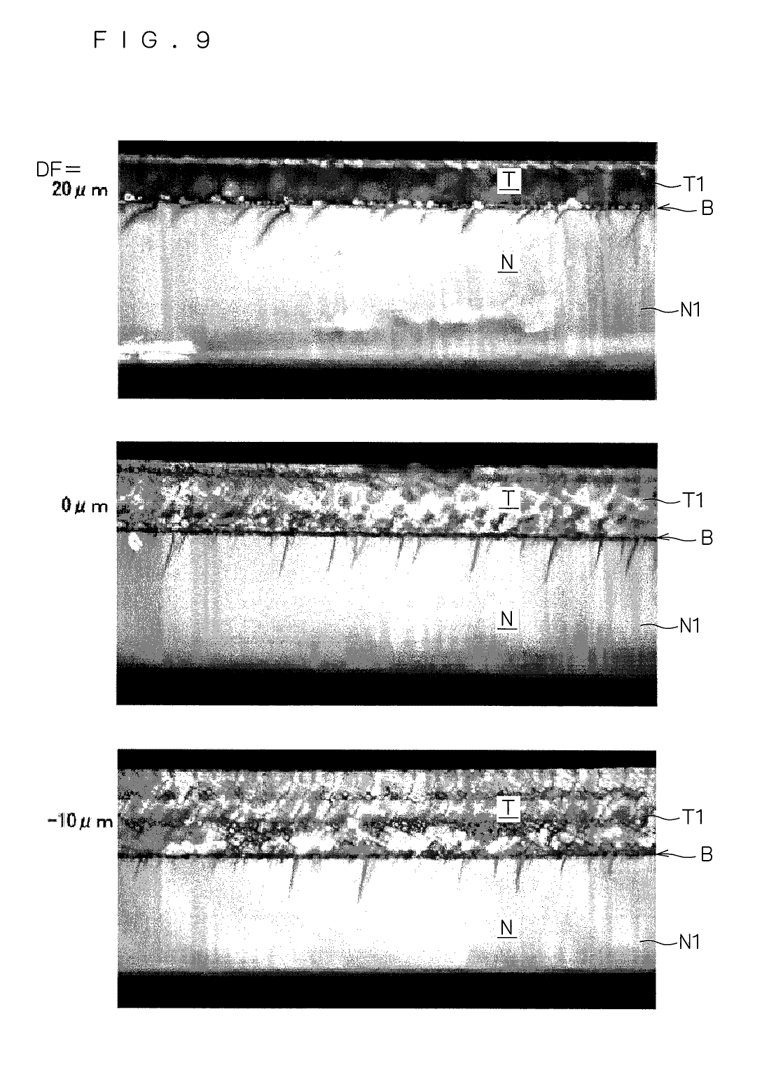

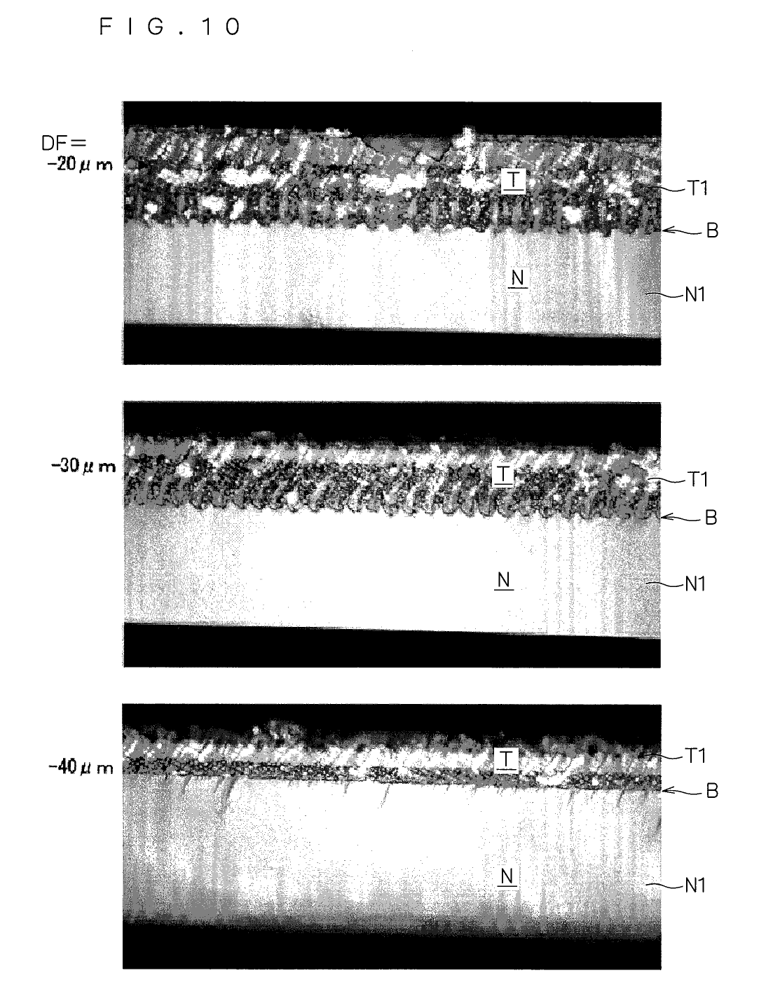

Subsequently, with a known method, a break (splitting process) of the split object M was carried out for each of the scanning lines. For example, the break can be realized by exerting, from the top of the split object M, forces on the opposite sides with the scanning line interposed therebetween (namely with the affected region T interposed therebetween), in the opposite directions with the scanning line as the axis. FIG. 9 and FIG. 10 show optical microscope images of the break surfaces in the scanning lines with regard to some defocus values DF.

Referring to FIG. 9 and FIG. 10, at every location, the break surface consists of two layers of a break surface T1 of the affected region T, and a break surface N1 of the normal region N, and the interface between the two is substantially parallel to the top and bottom surfaces of the split object M. From this, it can be decided that in the splitting of the normal region N, the lowermost end B of the affected region T functioned as the originating point, and the splitting was progressed downward. As long as FIG. 9 and FIG. 10 are viewed, since the normal region N is substantially flat, it can be regarded that the break surface N1 of the normal region N can be formed toward immediately below the lowermost end portion B of the affected region T, and in substantially perpendicular to the top and bottom surfaces of the split object M.

Consider the process where the above break can be realized. First, it can be considered that the affected region T was formed through the process where by the irradiation of the laser beam LB, rapid heating and rapid cooling due to the absorption occurred at the irradiation position P and therebelow, and then the irradiation portion being initially single crystal was temporally melted and polycrystallized. That is, the affected region T can be considered to be the region altered by melting and also the region having lower strength than the normal region N retaining the single crystal state. Therefore, it seems that when break is made along the affected region T, the break occurs preferentially at the affected region T of low strength, however, as the result, stress can be concentrated at the lowermost end portion B of the affected region T, whereby the break of the normal region N can be progressed with the lowermost end portion B as the originating point. Moreover, since the affected region T can be formed substantially vertically to the top and bottom surfaces of the split object M, it can be considered that at the time of the break, the break progressed to the lowermost end portion B in the direction perpendicular to the top surface in the affected region T can also be progressed in the same direction in the normal region N, and as the result, a substantially flat break surface N1 as shown in FIG. 9 and FIG. 10 can be obtained.

Consequently, it can be said that, without irradiating the laser beam of strong energy at which a scribe groove can be formed on the split object M, only if a laser beam, for example, as that under the first irradiation condition is irradiated to cause melting alteration thereby to form the above-mentioned affected region at a desired split position, the lowermost end portion of the affected region can function as the originating point at the time of the break, making it possible to break the split object M. The technique of causing melting alteration of the irradiation portion by irradiating the laser beam as described above is referred to as laser melting alteration.

<Relationship Between Defocus and Affected Region>

Although it is ideal that the break surface N1 obtained by the break is completely perpendicular to the top and bottom surfaces of the split object M, if it is within the range of the required dimensional precision even when there are differences in the size and shape after splitting, no practical problem arises even if such an ideal state is not always realized.

For example, when the defocus value DF in FIG. 9 is 20 μm, the image in the vicinity of the bottom surface of the split object M in the break surface N1 of the normal region N appears slightly fuzzy. It can be assumed that at this region, the break surface N1 has a somewhat tilting (with respect to the plane parallel to the drawing). Also, in the cases of the respective defocus values DF shown in FIG. 9, and when the defocus value DF is −40 μm as shown in FIG. 10, a longitudinal stripe can be observed at the upper end portion of the normal region N. This seems to be because the break surface N1 has a slight level difference in a direction perpendicular to the drawing. On the other hand, when the defocus value DF is set to −20 μm and −30 μm as shown in FIG. 10, the result is a good break surface N1 where contrast is uniform and no string is observed. Whether or not the above-mentioned tilting and the level difference are permissible differs depending on the required break precision.

Even so, it seems to be some cause-effect relationship between the difference in defocus value DF and the break quality. From the viewpoint of yield and repeatability, it is preferable that a break of good dimensional precision can be realized. Now consider the relationship between the defocus value DF when a good break can be realized, and the state of the affected region T.

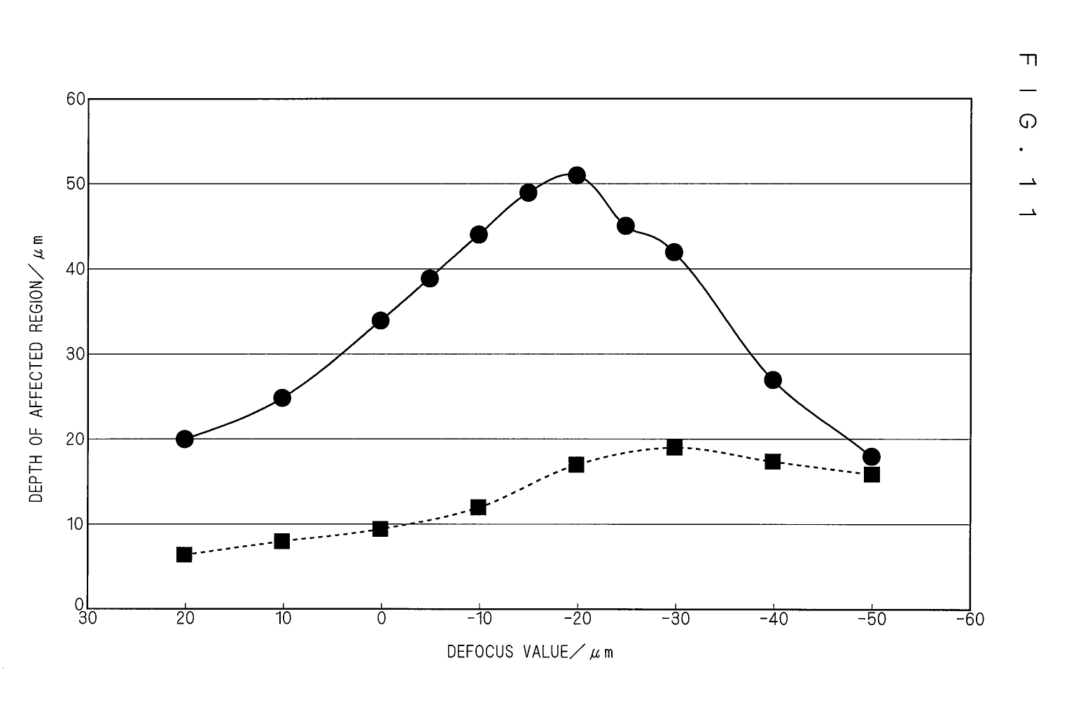

Firstly, from the fact that the lowermost end portion of the affected region T functions as the originating point at the time of the break, it seems to be desirable for a good break that the distance between the lowermost end portion and the bottom surface being the end point of the break is short, namely the affected region T is deeper. In FIG. 11, the relationship between the defocus value DF and the depth of the affected region T (the distance from the top surface of the lowermost end portion) is indicated by the solid line. In accordance with FIG. 11, as the defocus value DF becomes smaller than 20 μm, the affected region T becomes deeper, and it becomes the maximum in the vicinity of −20 μm. Up to −30 μm, the depth of the affected region is considerably larger than the absolute value of the defocus value DF.

Furthermore, as can be seen from FIG. 6 and FIG. 7, as to the affected region T, not only the depth but also the shape changes with the change of the defocus value DF. Specifically, when the defocus value DF is −10 μm to −30 μm, the width in the direction perpendicular to the scanning direction in the top surface of the affected region T falls within 20 μm or below. Additionally, in the cross section of the affected region T, the width of the upper end portion becomes small and elongated as the defocus value DF becomes small from 20 μm to a negative value. That is, it can be confirmed there is the change so that the lowermost end portion reaches a further underside and the curvature of the interface between the affected region T and the normal region N becomes small. Here, the shape of the interface when the defocus value DF is 20 μm is taken to have a positive curvature. Including the cases where the defocus value DF is −20 μm and −30 μm, the interface except for the upper part is substantially linear. Alternatively, the cross-sectional shape is a substantially wedge shape, or alternatively a substantially isosceles triangle. However, exceeding −30 μm, it can be confirmed the change that the upper end portion becomes wide and the depth becomes small, while maintaining the substantially linear interface shape.

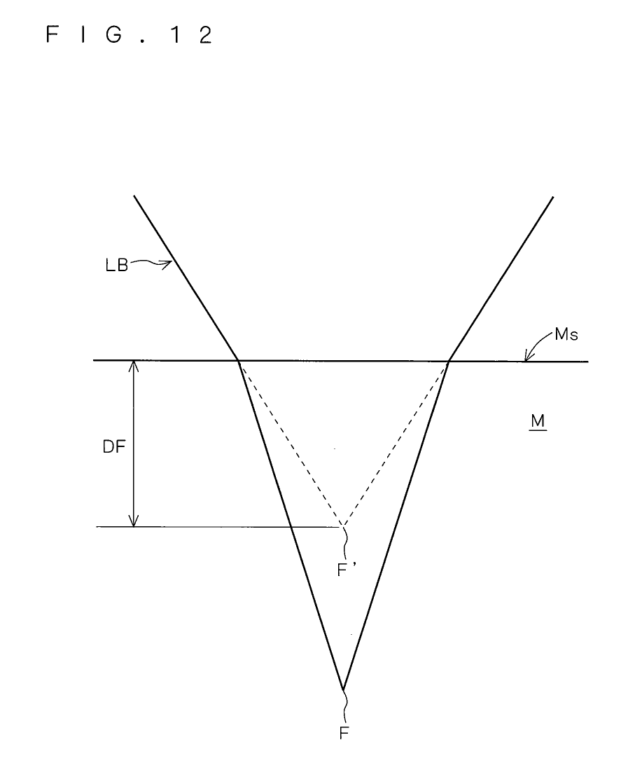

FIG. 12 is a diagram showing schematically the actual irradiation state of the laser beam LB at the time of the defocus. The case where the defocus value DF is negative is the case of irradiating the laser beam LB with the intention that the focus F is offset by the distance corresponding to the defocus value DF, as shown in FIG. 4(c). In fact, because the irradiated laser beam LB is subjected to refraction on the top surface Ms of the split object M, it is further narrowed in the inside of the split object M, resulting in the irradiation so that the focus F reaches a deeper location than the position assumed from the offset value (shown as a focus F′ for convenience's sake). Thus, the laser beam LB locally enters inside, so that energy absorption occurs not only on the top surface Ms but the entire irradiation region whose cross section is triangle with the focus F as the vertex, and particularly, significant absorption occurs at the focus F that is the internal optical focusing point. As the result, the energy of the laser beam LB efficiently contributes to the generation of an affected region, and the generated affected region T has a cross-sectional shape which is gradually elongated from the surface and the lowermost end portion of which reaches a deeper location. In other words, the affected region T can be formed so that its cross section has an isosceles triangle (the curvature is zero) having a smaller base and a great height (depth), or so as to have an interface whose curvature is further negative than that. It seems that this situation can be realized until the defocus value is about −30 μm. It is noted that the effect of the simultaneous adsorption of energy appears more significantly in the split object of a high transparency.

However, when the defocus value is too large, the focus F may be separated from the top surface Ms of the split object M. In this case, the laser beam LB cannot be condensed sufficiently on the top surface Ms of the split object M, resulting in the irradiation with a small energy density. Therefore, it can be said to be difficult to form a deep affected region T. It seems that this situation can be realized when the defocus value DF exceeds −40 μm.

In view of the foregoing, it can be said to be suitable for realizing a good break to form the affected region whose curvature in the interface with the normal region is close to zero or is a negative value, and which has an elongated cross-sectional shape, by irradiating the laser beam LB setting the defocus value DF to approximately from −10 μm to −30 μm, more preferably setting the defocus value DF to approximately from −20 μm to −30 μm. In this case, it is sufficient to ensure 20 μm at the most as the necessary region width (street width) for the break in the top and bottom surfaces of the split object M, and it is therefore possible to further increase the obtainable number when cutting a large number of chips or dies.

Provided that, instead of forming the affected region by laser melting alteration as in the present embodiment, a “scribe groove” is formed so as to have the same elongated cross-sectional shape as the affected region to be formed on the split object M by using the above-mentioned preferable defocus value DF, it is necessary to irradiate a laser beam under a condition where ablation occurs only in a local region of a width of 20 μm or less. That is, it is necessary to irradiate the laser beam having a larger energy density than the case with the present embodiment, without expanding it in the inside of the split object. This laser irradiation consumes more energy uselessly than the present embodiment, and also makes it difficult to control the irradiation region. In addition, when an epitaxial layer or the like is formed on the opposite side of the irradiated surface, the danger of damage to this layer is also increased. That is, the method employing laser melting alteration according to the present embodiment can be said to be superior as the technique of forming the split originating point.

<Relationship Between Pulse Width and Affected Region>

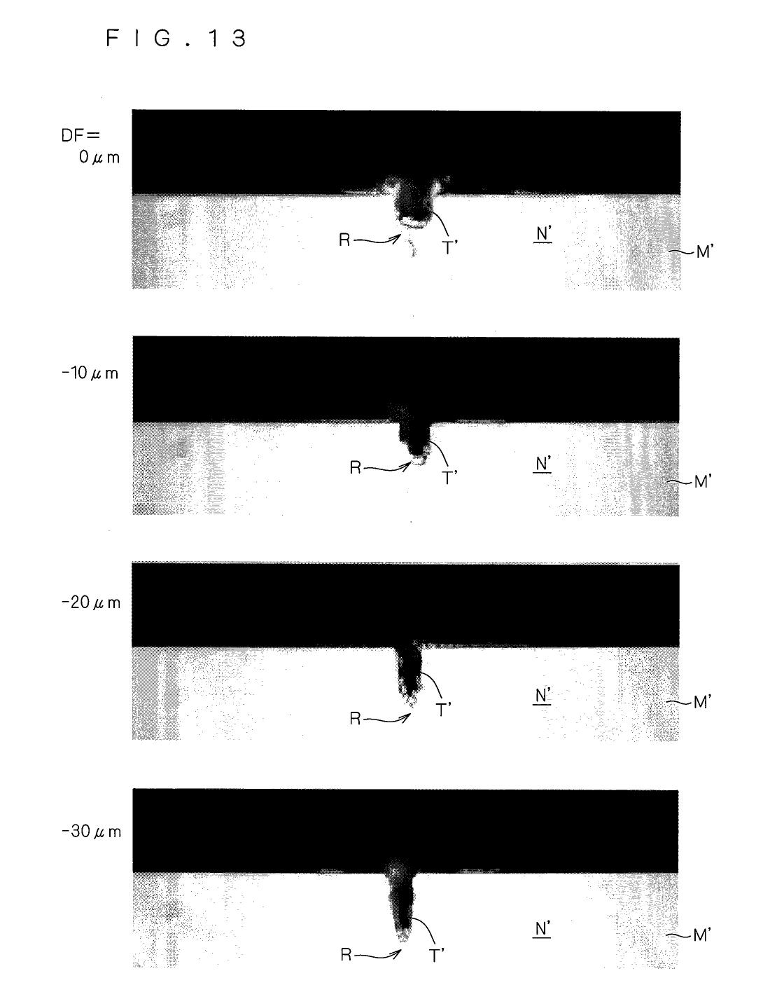

Consider next the relationship between the magnitude of a pulse width and the shape of an affected region to be formed. FIG. 13 shows the optical microscopic image of the cross section of a split object M′ when the laser beam LB was irradiated to the split object M′ in the same manner as above, except that the pulse width was set to 13.5 nsec. The irradiation condition of the laser beam LB in this case is referred to as a “second irradiation condition.”

Here, the fact that only the pulse width is different means that the total energy is the same but the peak value is different in respect to each pulse (unit pulse) of the laser beam irradiated repetitively. Speaking in more detail, it means that the changing waveform of irradiation energy with respect to time base can be expressed by a similar function, but its height and width are different. Since a larger energy peak can be obtained in the unit pulse by setting the pulse width to a small value, in general, it seems to be preferable to minimize the pulse width as much as possible in ablation fabrication processing. Accordingly, the case of irradiating the laser beam LB under the second irradiation condition as described below corresponds to the execution of fabrication processing under the condition as in the case of executing this ablation fabrication processing.

As shown in FIG. 13, it can be confirmed that also in the case of the second irradiation condition, an affected region T′ can be formed irrespective of the defocus value DF. However, the cross section of the affected region T′ is not so deep as in the case of the first irradiation condition, even when the defocus value DF is −20 μm or −30 μm. In FIG. 11, the change in the depth of the affected region T′ in this case is shown by the dotted line. Even when the defocus value DF is set to be negative, no significant change in the depth direction can be observed, and the value is smaller than under the first irradiation condition and the depth of the affected region T′ does not considerably exceed the absolute value of the defocus value DF. This means that the formation of the affected region is governed by the energy absorption on the surface of the split object, failing to obtain the effect of simultaneous absorption in the entire irradiation region by means of defocus. Under the first irradiation condition, including the cases where the defocus value is positive, the depth of the irradiation region is large. Therefore, it can be said that the irradiation of the laser beam at such a pulse width as to cause ablation is unsuitable in forming the affected region for obtaining the originating point of the break.

In addition, in a region R in the vicinity of the lowermost end portion of the affected region T′ in a normal region N′, a crack can be observed in either case. In the presence of this crack, though a break itself can occur, at the time of the break, the originating point of the break in the normal region N′ will vary depending on the location, and therefore the likelihood that it is impossible to obtain a flat break surface can be increased, and this is unfavorable.

From these, by irradiating the laser beam of a large pulse width causing no ablation, the pulse laser beam can be irradiated at a more suitable waveform for forming the affected region having a suitable cross-sectional shape for splitting. A superior break can be realized by forming the affected region by the laser melting alteration due to the irradiation of this laser beam. Specifically, it is preferable that the laser beam is irradiated at a pulse width of not less than 50 nsec.

<Relationship Between Irradiation Energy and Affected Region>

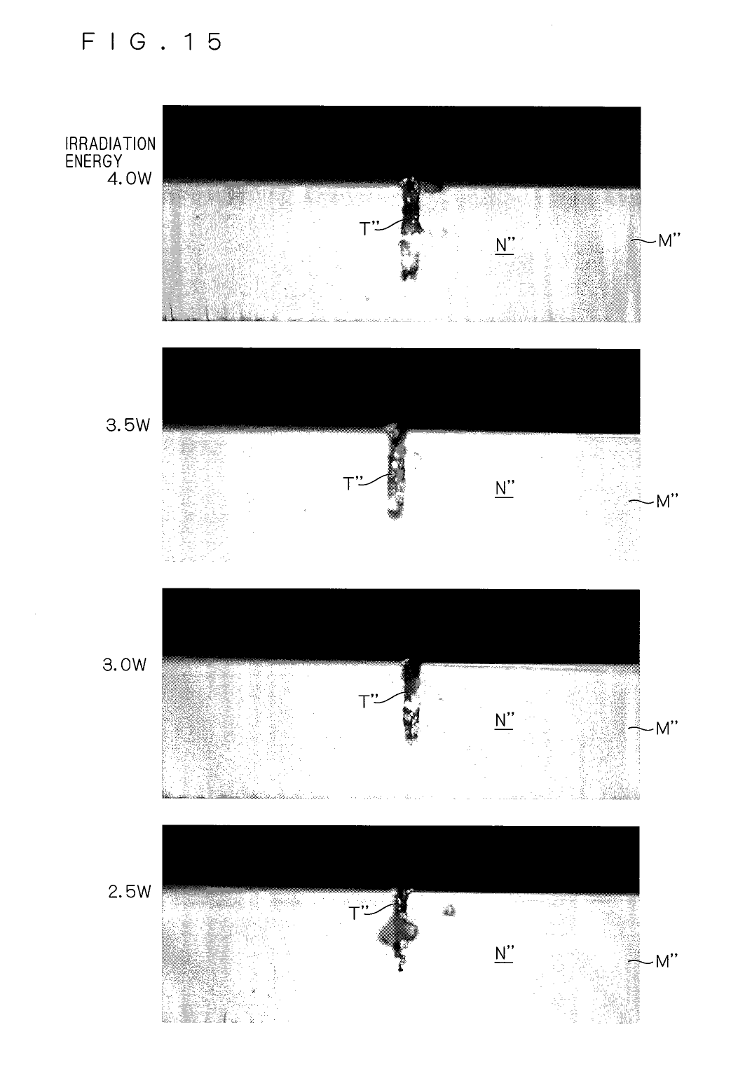

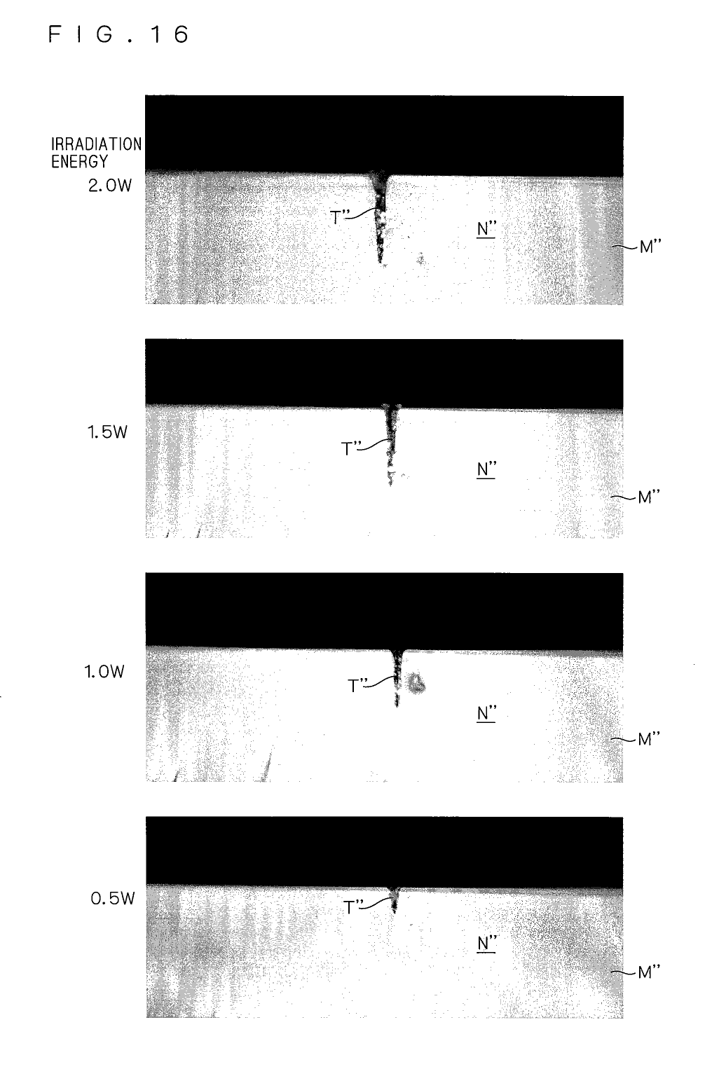

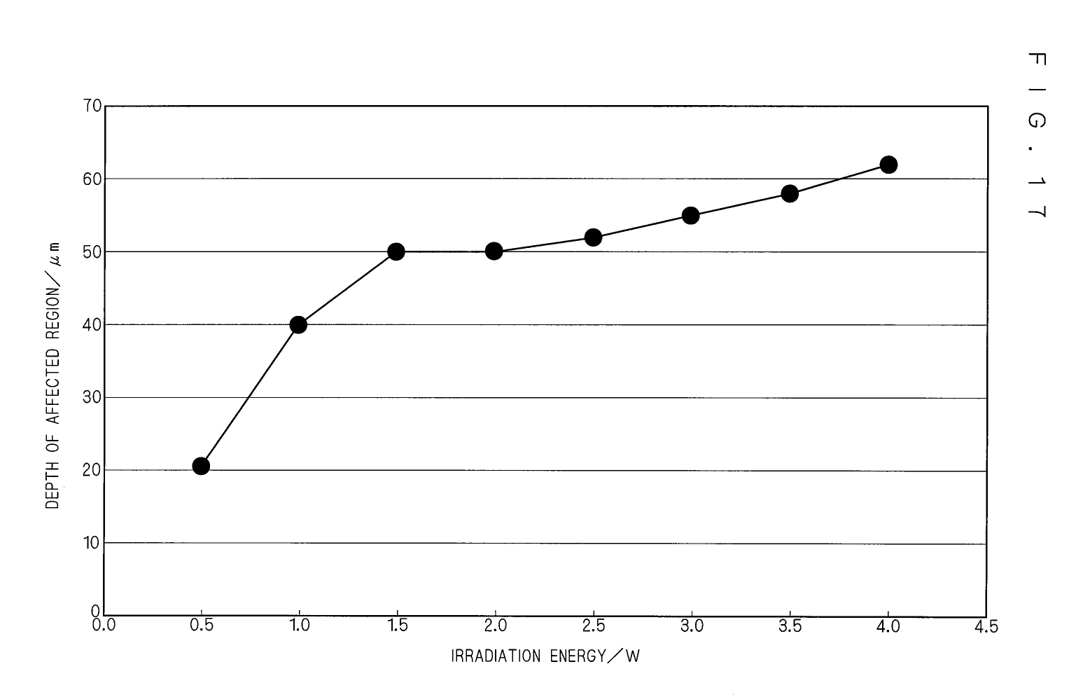

Consider next the relationship between the magnitude of irradiation energy to a split object, and the shape of an affected region to be formed. FIG. 15 and FIG. 16 show the optical microscopic images of the cross sections of a split object M″ for each irradiation energy when the laser beam LB is irradiated to the split object M″ by setting the pulse repetition rate to 40 kHz, the pulse width to 75 nsec, the beam diameter at the focus F to 2 μm, and the defocus value to −20 μm, and by changing the irradiation energy in the unit of 0.5 W in the range of 4.0 W to 0.5 W. FIG. 17 is a diagram showing the relationship between the irradiation energy and the affected region T″ in this case.

Referring to FIG. 15 and FIG. 16, when the irradiation energy is 2.0 W or below, the interface between the affected region T″ and a normal region N″ is substantially linear except for the upper part. Alternatively, the cross-sectional shape is a substantially wedge shape, or a substantially isosceles triangle. In contrast, when the irradiation energy is not less than 2.5 W, the width of the affected region T″ is further increased, and as the curvature of the interface is also increased. From FIG. 17, it can be confirmed that as the irradiation energy is increased, the depth of the affected region T″ is generally increased, however, the degree of the increase drops rapidly when it exceeds 1.5 W. It has been confirmed that there is a similar tendency even if the conditions such as pulse repetition rate and pulse width are different, which are not shown.

It can be said from these that supplying the irradiation energy of not less than a certain value (1.5 W in FIG. 17) merely causes an expansion in the horizontal direction of the affected region, and rather suppressing the irradiation energy to a certain degree is suitable for forming the affected region functioning as a good split originating point by laser melting alteration. Although a specific optimum value of irradiation energy shall be determined depending on the pulse repetition rate, the pulse width, the beam diameter, and the defocus value, it can be said that the range of 1.0 W to 1.5 W is suitable for the case of FIG. 17. That is, a good split originating point can be formed on the split object, while suppressing the irradiation energy.

As described above, in the present embodiment, by irradiating the laser beam LB at weak energy and a large pulse width than that in the case where the scribe groove can be formed on the split object M, and by setting the defocus value DF to approximately from −10 μm to −30 μm, more preferably by setting the defocus value DF to approximately from −20 μm to −30 μm, laser melting alteration can be caused at the irradiated portion thereby to form an affected region whose curvature in the interface with the normal region is close to zero or is a negative value, and which has an elongated cross-sectional shape is formed on the split object. Thus, the lowermost end portion of the affected region functions as the originating point at the time of the break processing, thereby realizing a good break where the break surface is substantially perpendicular to the top and bottom surfaces of the split object, and there is no level difference in the break surface. In addition the necessary street width for the break can be controlled to 20 μm or below.

Furthermore, since there is no need to form the scribe groove, the energy consumption can be suppressed, and the control of the laser beam irradiation can also be facilitated.

### Second Embodiment

### Making Sure of Forming Split Originating Point

As described above, by forming the affected region functioning as the originating point of splitting by the laser melting alteration, it is possible to perform splitting of a split object without necessarily forming a groove. However, in this manner, in the split pieces such as chips and dies obtained by the splitting, the affected region might remain in the vicinity of the break surface. For example, the break surface T1 in FIG. 9 and FIG. 10 can be said to correspond to the surface of such a remaining affected region. When the split piece is used as a device, the presence of the remaining affected region can be a factor of inhibiting sufficient exhibition of the function thereof. For example, when the split piece is used as an LED, there might arise the problem that the quantity of light emission of the entire LED can be suppressed by the presence of the remaining affected region whose light transmittance is smaller than that of the normal region.

It is therefore preferable that the affected region is minimized in such a range as to be able to perform splitting. For that, it is preferable to suppress the energy of a laser beam irradiated in the laser melting alteration. For example, when fixing the pulse repetition rate, this can be achieved by suppressing as much as possible the pulse energy of the laser beam irradiated (the energy of a laser beam for one pulse). On the other hand, the suppression of the pulse energy can cause uncertainness of the originating point formation, specifically uncertainness of the laser beam absorption. Accordingly, in order to form stably the split originating point by using a laser beam of small pulse energy, it is effective to handle so that the laser beam can be surely absorbed at a location where the split originating point will be formed by, for example, increasing the efficiency of absorption.

Also, when forming a split originating point on a split object having a high transmittance and a high reflectance in the wavelength range of a laser beam used for fabrication processing, the affected region functioning as the split originating point can be formed surely without supplying pulse energy than necessary, by carrying out a similar handling in advance. The present embodiment will describe these modes.

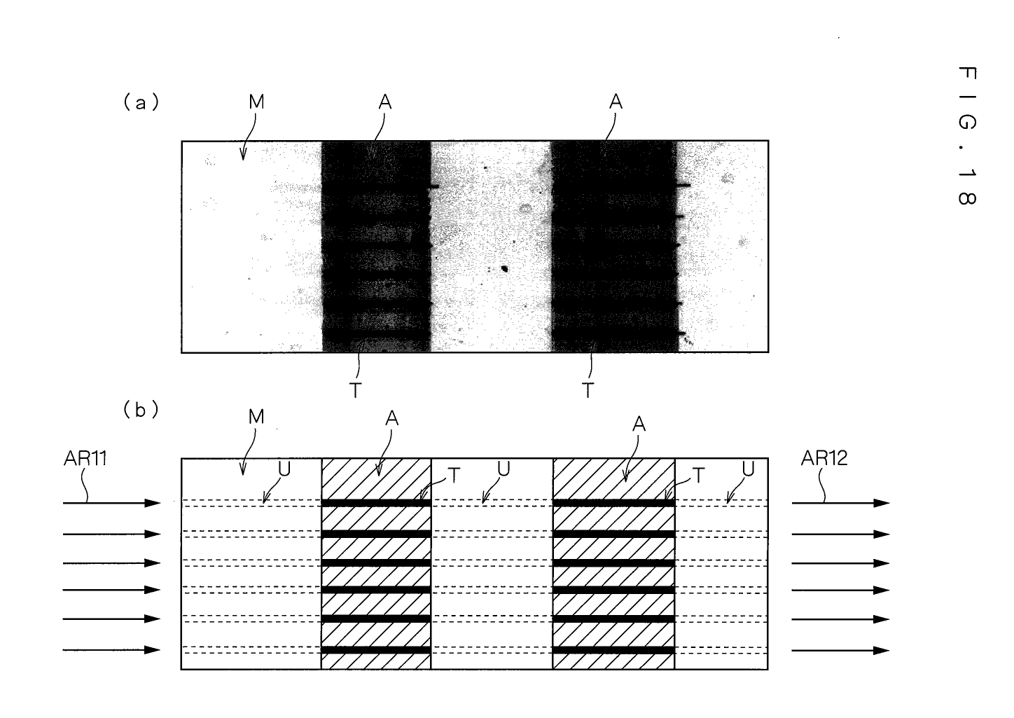

FIG. 18 is a diagram for explaining an example of the processing that realizes making sure of absorption of this laser beam. In FIG. 18, there is illustrated the case where the split object M is a sapphire substrate. FIG. 18(a) is an optical microscopic image showing the irradiation result when a laser beam is irradiated in the state where a material A having a higher absorptance than the split object M is supplied to the surface of the split object M. FIG. 18(b) is a diagram for explaining how the irradiation result of FIG. 18(a) was obtained. The irradiation result as shown in FIG. 18(a) can be realized, in cases where the split object is a sapphire substrate and the triple harmonics of Nd:YAG laser (approximately 355 nm in wavelength) is used, under a condition where the pulse energy is 2 to 5 μJ, and the scanning speed is not less than 100 mm/sec. The specific irradiation condition of the laser beam when the irradiation result as shown in FIG. 18(a) was obtained is that the scanning speed is 200 mm/sec and the pulse energy is 3 μJ. The irradiation of this laser beam is referred to as a “third irradiation condition.”

The material A is also a material having a higher absorptance than the split object M in the wavelength range of a laser beam used. In the example of FIG. 18, the supply of the material A is realized by directly coating oil based ink used in felt pens or the like. Alternatively, instead of this, other organic material or an inorganic material may be used. The mode of supplying is not limited to coating, and a mode according to the kind of the material A, such as bonding or sticking, or a thin film forming technique such as deposition, thick film forming technique such as printing, or the like, may be employed suitably.

With respect to the split object M in FIG. 18(a), as shown by the arrows AR11 and AR12 in FIG. 18(b), a laser beam is irradiated continuously at equally spaced intervals, while scanning the laser beam from the left side to the right side in the drawing, including the region that is not shown. However, in accordance with FIG. 18(a), the region where an affected region T is formed is nearly only the region on which the material A is coated. In the region where the material A is not coated, no alteration occurs although the laser beam has been irradiated. Specifically, an unaffected region U shown in FIG. 18(b) corresponds to this. In other words, the affected region T can be surely formed in the region where the material A is supplied, whereas the affected region is hardly formed in the region where the material A is not supplied.

This means that by performing a preparatory processing of supplying, to a location to be split, a material having a higher absorptance of the laser beam than the split object M in the wavelength range of a laser beam used, the laser melting alteration can be caused to stably form an affected region capable of being the split originating point, even if the irradiation is carried out under an irradiation condition of weak energy at which any affected region cannot be formed without the above supply. That is, the material A functions as an absorption assistant that enhances the absorption efficiency of the laser beam in the split object M.

Therefore, by supplying in advance the material acting as the absorption assistant to the split location of the split object M so that the absorption efficiency of the laser beam can be increased only at this location, the formation of the split originating point can be carried out surely even by the irradiation of the laser beam as described as the third irradiation condition, with which absorption does not occur sufficiently by nature, and even melting alteration does not occur. For example, in the manufacturing step of a certain device, if the method of forming the split originating point according to the present embodiment is used for breaking the device, the energy of the laser beam used can be suppressed and hence this method can be said to contribute to reductions in the manufacturing costs.

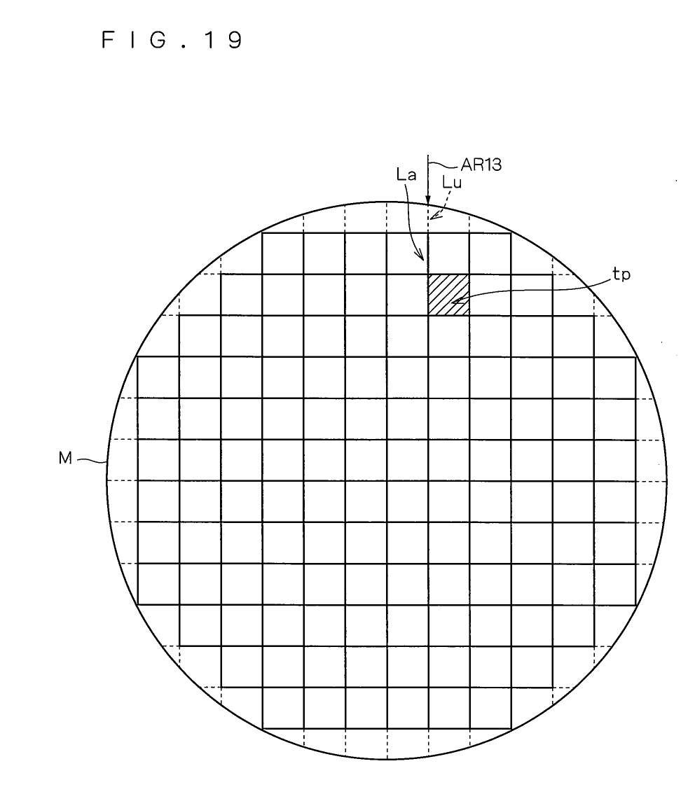

FIG. 19 is a diagram illustrating specifically the use of the method according to the present embodiment. When tips tp are obtained by splitting the split object M shown in FIG. 19, if the material A acting as the absorption assistant is supplied in advance to the portion of a line La indicated by the solid line, for example, with regard to cutting along a cut line indicated by the arrow AR13, the laser beam can be irradiated under a condition where no absorption occurs in a line Lu indicated by the broken line, and only at the portion of a line La, absorption can occur to form an affected region due to melting alteration. A specific irradiation condition can be determined suitably depending on the type of the split object M and its surface state, the type of laser, and the type of a material used as the absorption assistant. This is true for the size (thickness, width, and the like) of the absorption assistant when it is supplied. This enables the split originating point to be surely formed at the corresponding portion.

For example, in cases where the split object is a sapphire substrate and the triple harmonics of Nd:YAG laser (approximately 355 nm in wavelength) is used, it is possible to realize under a condition where the pulse energy is 2 to 5 μJ, and the scanning speed is not less than 100 mm/sec.

### Third Embodiment

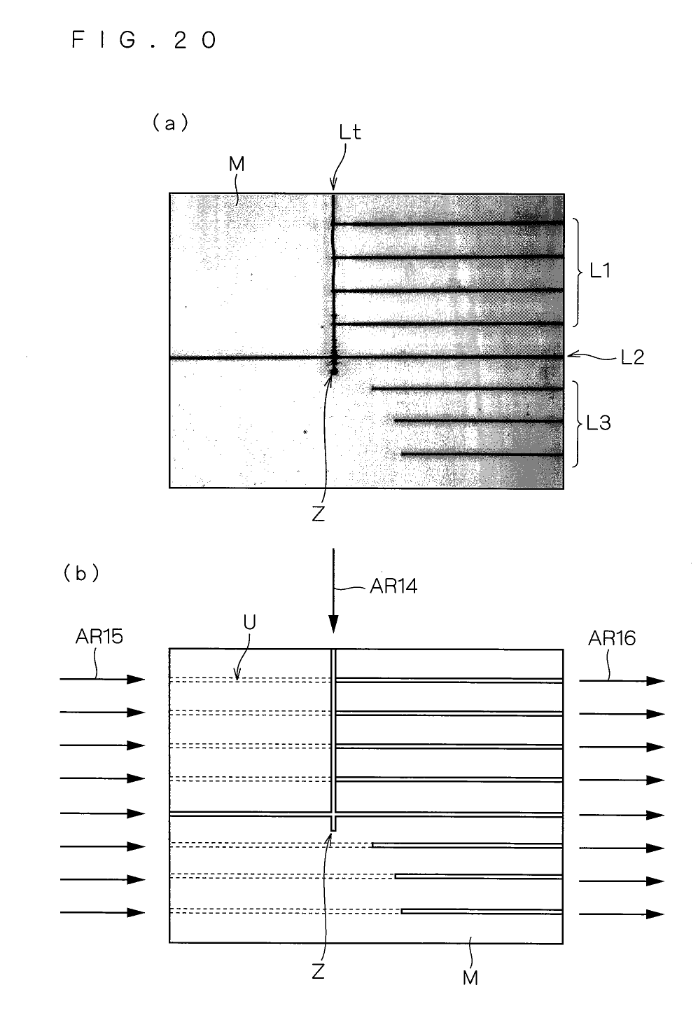

The present embodiment describes other mode of the processing that realizes making sure of absorption of a laser beam, namely making sure of melting alteration. FIG. 20 is a diagram showing an example of this processing. In FIG. 20, there is illustrated the case where the split object M is a sapphire substrate.

FIG. 20(a) is an optical microscopic image showing the irradiation result when a laser beam is irradiated to the split object M. The irradiation result can be realized in the following manner that an affected region indicated by a processing line Lt is formed in advance by irradiating a laser beam under a predetermined irradiation condition to the surface of the split object M, directing from above the drawing to a point Z, as shown by the arrow AR14 in FIG. 20(b), and then irradiating the laser beam continuously at equally spaced intervals, while scanning the laser beam, including the region that is not shown, from the left side to the right side in the drawing as indicated by the arrows AR15 and AR16 in FIG. 20(b), namely so as to be orthogonal to the processing line Lt.

Here, the former irradiation is referred to as a preliminary irradiation, and the latter irradiation is referred to as a main irradiation. The specific laser beam irradiation condition when the irradiation result shown in FIG. 20(a) was obtained is that the pulse energy is 3 μJ, and the scanning speed is 100 mm/sec. The irradiation condition in the main irradiation is referred to as a “fourth irradiation condition.” If the preliminary irradiation is carried out so as to supply stronger energy than the fourth irradiation condition, the condition thereof is not particularly limited.

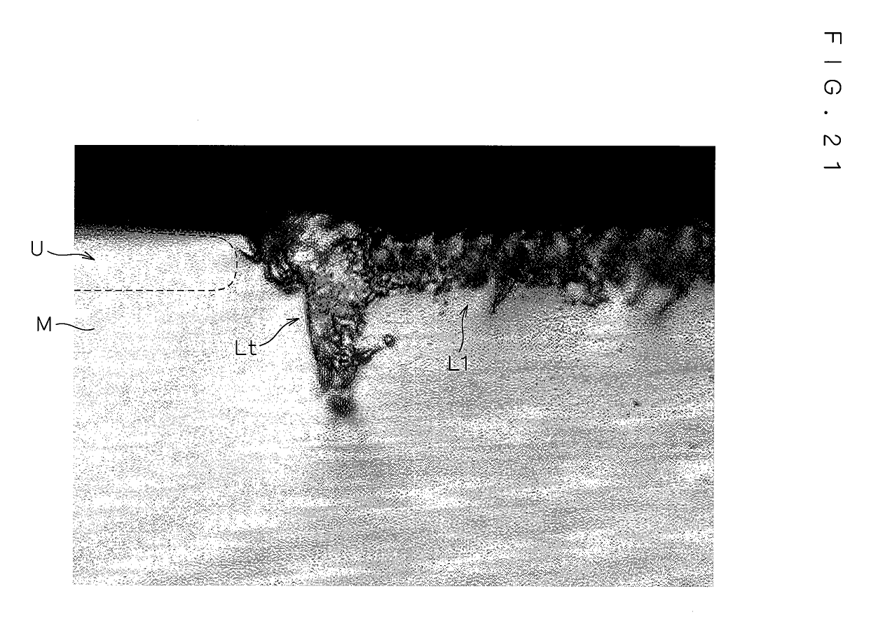

Referring to FIG. 20(a), the affected region indicated by the processing lines L1, L2 and L3 are formed on the split object M by the main irradiation. In these, the processing lines L1 are formed only on the right side from the processing line Lt by using, as the starting point thereof, the location where the processing line Lt is present. That is, the left side from the processing lines Lt corresponds to an unaffected region U where no alteration occurs though the laser beam has been irradiated, as shown in FIG. 20(b). FIG. 21 is a sectional view of the split object M in a plane having the processing line L1, and this can also be confirmed from FIG. 21. On the other hand, the processing lines L3 are formed only on the right side from the starting point thereof which is present on the right side from the processing lines L1, and the positions of their respective starting points do not line up. The processing line L2 is formed using, as the starting point thereof, a position (not shown) on the left side from the position of the processing line Lt.

Consider the irradiation results. First, the processing lines L1 are formed by using as a so-called trigger, the processing line Lt that has been formed intentionally by the preliminary irradiation, and hence their respective starting points can be said to line up. Further, the processing lines L1 are continuously formed without discontinuance from the position of the processing line Lt functioning as the starting points. In other words, it can be said that the laser beam irradiated under the fourth irradiation condition is surely absorbed in the affected region indicated by the processing line Lt, and the absorption is continued from then on, though the laser beam cannot be absorbed before it reaches the processing line Lt.

In contrast, it can be said that since the formation of the processing lines L3 is carried out in the region where any location functioning as the trigger is not intentionally formed, the starting points thereof do not line up.

From these contrasts, it can be said that at least in the laser beam irradiation under the fourth irradiation condition, the affected region given as the processing line Lt acts to surely cause the absorption of the laser beam. As described above, the affected region is the region polycrystallized by rapid heating and rapid cooling due to the absorption, and also the region of high absorption efficiency which is susceptible to absorption of the laser beam than the surrounding region not being affected. It can therefore be considered that the corresponding position is subjected to absorption even by the laser beam of weak pulse energy at which no absorption occurs until it reaches the processing line Lt. Further, the laser beam is irradiated, while scanning, and the irradiation region per pulse slightly shifts, while overlapping with each other. Therefore, if once such absorption has occurred, the laser beam will move, while retaining the corresponding absorption state. That is, even by the laser beam of weak pulse energy, the melting alteration can be caused continuously to form an affected region. Referring to FIG. 21, the affected region by the processing line L1 is shallower than the affected region by the processing line Lt, and this means that the laser beam energy in the main irradiation may be smaller than at least the energy in the preliminary irradiation.

The processing line L3 can be formed though any one functioning as the trigger of absorption, such as the processing line Lt, is not provided. If occurred unintentionally some situation where the laser beam can be absorbed in the surface of the split object M, the absorption of the laser beam can occur. Therefore, for example, by the adhesion of particles or the presence of a surface defect, the absorption can occur even by the irradiation of pulse energy at which absorption does not usually occur. In other words, it can also be said that the formation of the processing line L3 is due to that the laser beam absorption occurs accidentally at the starting point position. Although these defects and the like are not introduced intentionally, they actually function to increase the absorption efficiency of the laser beam. This means that only such uncertain absorption occurs by merely irradiating the laser beam of weak pulse energy.

In addition, the formation of the processing line L2 is initiated before it reaches the processing line Lt, though it passes through the position where the processing line Lt is formed. This can also be considered to be due to that absorption occurs accidentally before the laser beam reaches the processing line Lt.

In view of the foregoing, by performing the preparatory processing (a starting point alteration process) for forming in advance a region having a high absorption efficiency of the laser beam such as the affected region indicated by the processing line Lt, and then irradiating, while scanning the laser beam so as to pass through this region, even when using the laser beam of weak energy at which absorption does not occur sufficiently by nature, the absorption of the laser beam can be caused surely in the above region. Thereafter, the absorption can be continued successively according to the scanning of the laser beam, so that melting alteration can be caused to surely form the split originating point on the split object. A specific irradiation condition can be determined suitably depending on the type of the split object M and its surface state, the type of laser, and the like. This enables the split originating point to be surely formed at the corresponding portion. Furthermore, it can also be said that in cases where the method of forming the split originating point according to the present embodiment is used in the manufacturing step of a certain device in order to break the device, this method can contribute to reductions in the manufacturing costs.

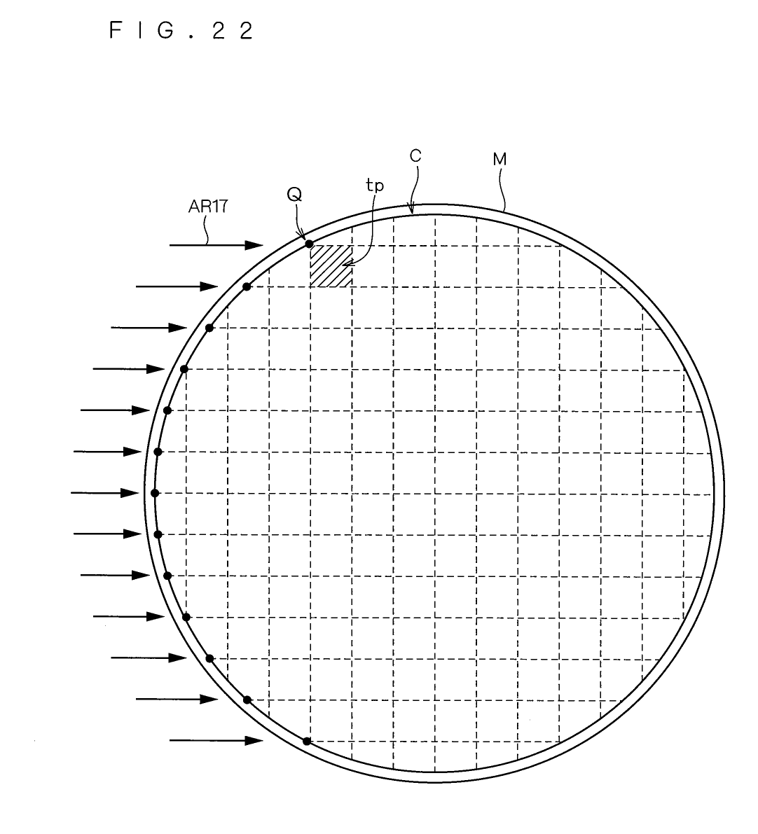

FIG. 22 is a diagram illustrating specifically the method according to the present embodiment. When chips tp are obtained by splitting the split object M shown in FIG. 22, if an affected region is formed in advance by irradiating a laser beam to a location indicated by a peripheral line C of the outer edge portion of the split object M, for example, with regard to the cutting along a cut line indicated by the arrow AR16, the laser beam can be irradiated under such a condition where the absorption can occur at the point of time the laser beam reaches a starting point Q, and split originating points can be formed at locations indicated by the dotted lines.

For example, in cases where the split object is a sapphire substrate and the triple harmonics of Nd:YAG laser (approximately 355 nm in wavelength) is used, the formation of an affected region functioning as a split originating point can be realized under a condition where the pulse energy is 2 to 5 μJ, and the scanning speed is not less than 100 mm/sec.

### Fourth Embodiment

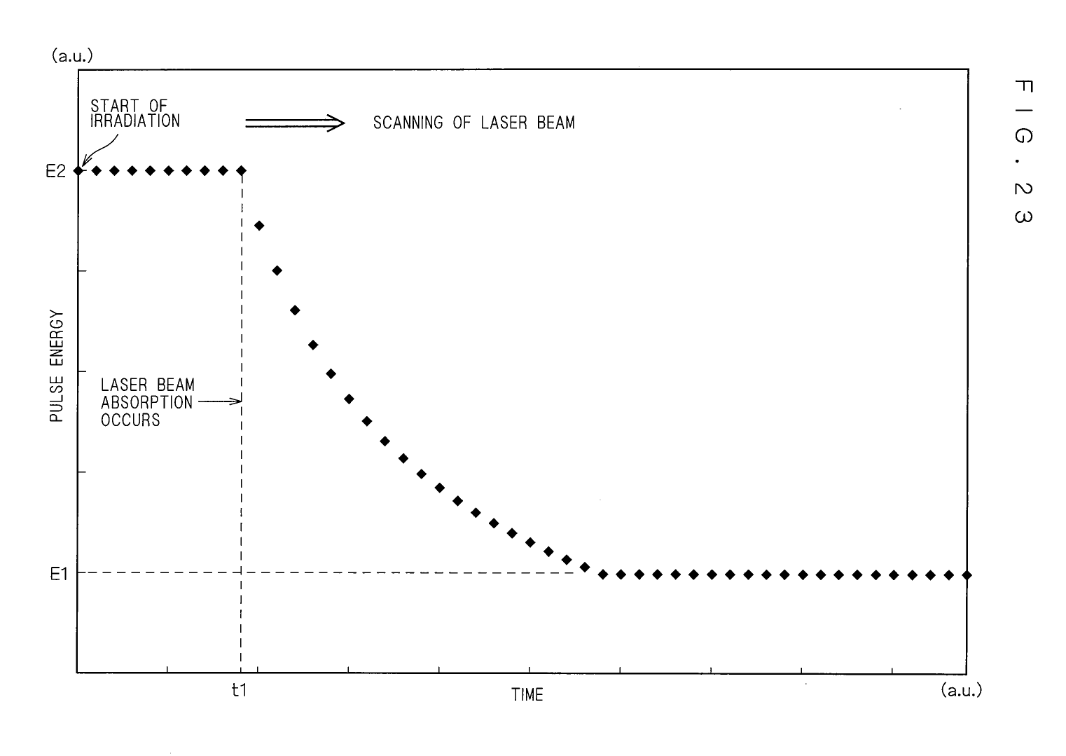

As described in the third embodiment, when an affected region capable of being a split originating point is formed on a split object by irradiating the laser beam while scanning it, only if absorption is caused surely by increasing, the absorption efficiency at the position of the starting point of the affected region, even when irradiating a laser beam of small energy at which no absorption occurs normally, the absorption state can be retained, enabling the formation of the affected region by causing melting alteration. In the present embodiment, a description will be made of other mode of making sure of absorption at the starting point. FIG. 23 is a diagram showing an example of the processing for this.

FIG. 23 is a diagram illustrating the change with time in the peak value of pulse energy of a used laser beam when an affected region functioning as a split originating point is formed on a certain split object by using laser melting alteration, according to the mode of the present embodiment. Also in the present embodiment, a split originating point is formed on a split object by irradiating a pulse laser beam with the use of, for example, the laser processing apparatus 100. Therefore, since the laser beam is irradiated at a predetermined pulse repetition rate, when forming the affected region functioning as the split originating point, the laser beam whose pulse energy exhibits intermittently a peak value, as shown in FIG. 23, will be irradiated to the split object. In FIG. 23, although the pulse energy is expressed as discrete values for the convenience for explanation, in fact, it can be handled as the value changing continuously.

In the present embodiment, as shown in FIG. 23, until some time t1 is elapsed from the early stages of irradiation, the laser light is irradiated at a pulse energy value E2 larger than a pulse energy value E1 in the steady state, and after an elapse of the time t1, the energy is gradually lowered to the steady state, while continuing the irradiation. Then, after the elapse of the time t1 at the latest, the laser beam is adapted to scan. Here, the pulse energy value E1 is a value at which no sufficient absorption occurs normally in the split object. On the other hand, the pulse energy value E2 is a value at which absorption occurs normally with near sure in the split object.

That is, the formation of the affected region functioning as the split originating point according to the present embodiment can be realized in the following mode that absorption is surely caused by performing the preliminary processing of irradiating once a laser beam with a large pulse energy at a position functioning as the starting point of the formation, and from then on, the absorption is continued to cause melting alteration by irradiating while scanning a weak laser beam at which no absorption occurs normally in the split objected. That is, this is the mode where the formation of the split originating point can be realized by setting the irradiation condition for causing absorption differently from the succeeding irradiation condition when forming the split originating point. Furthermore, it can also be said that in cases where the method of forming the split originating point according to the present embodiment is used in the manufacturing step of a certain device in order to break the device, this method can contribute to reductions in the manufacturing.

A specific irradiation condition such as the pulse energy values E1, E2, the value of the time t1 and others can be determined suitably depending on the type of the split object M and its surface state, the type of laser, and the like. Instead of setting the time t1 to a fixed value, the reduction of the pulse energy and the scanning may be started at the point of time that the occurrence of absorption of the laser beam in the split object is detected by a predetermined technique.

Like the third embodiment, the formation of the split originating point can also be carried out surely by the mode as described above.

### Modifications

A known blasting machine may be used to perform blast treatment on a region of the surface of a split object at which a split originating point will be formed, or a position functioning as the starting point of the region, so that a rough-surfaced state can be created in the region or the starting point position, thereby to increase the absorption efficiency of a laser beam at the region and the starting point position. Even with this mode, the same effect as the above-mentioned second or third embodiments can be attained.

Although in the fourth embodiment, the case of changing the pulse energy has been described as the mode of realizing the formation of a split originating point by setting the irradiation condition for causing absorption differently from the irradiation condition when forming the split originating point, the mode of making sure of absorption by changing the irradiation condition is not limited to this.

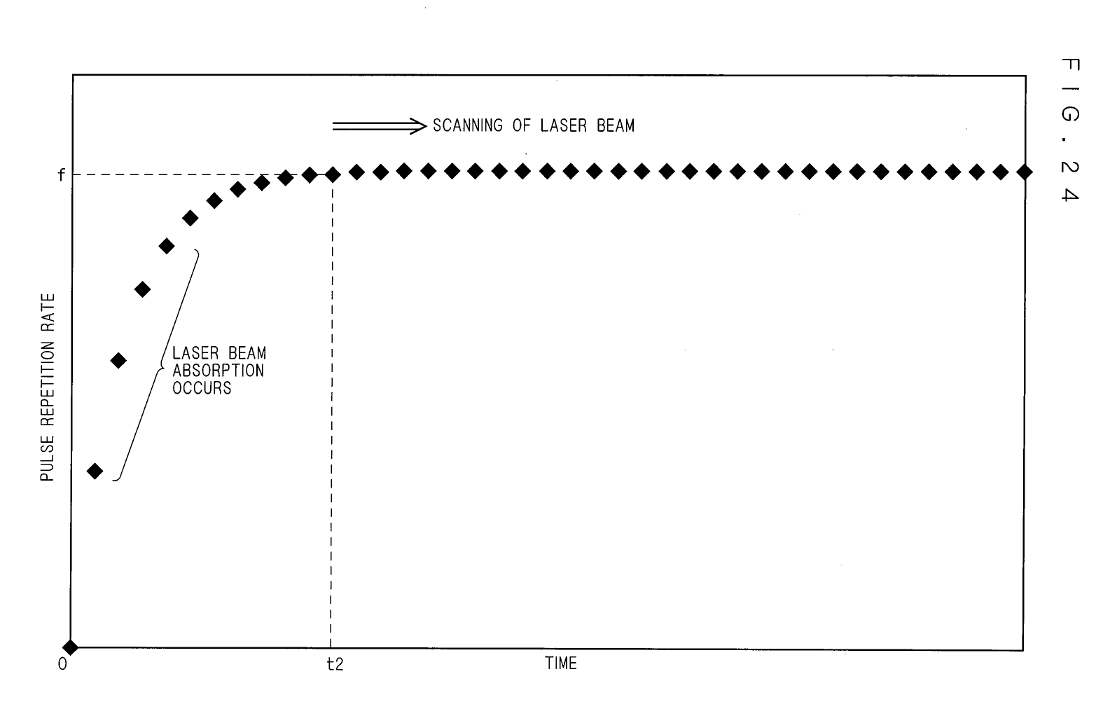

For example, FIG. 24 is a diagram showing a mode of changing the pulse repetition rate of a laser beam. Specifically, the irradiation of a laser beam is started at a pulse repetition rate sufficiently smaller than a value f in the steady state, and the pulse repetition rate is then gradually increased so that the frequency value is f at the point of time a certain time t2 is elapsed. Then, after the elapse of the time t2 at the latest, the laser beam is adapted to scan. At this time, the pulse energy value is a value at which no absorption occurs in the split object when the pulse repetition rate is f. If the average irradiation power is constant, at a small pulse repetition rate, the pulse energy is increased and the absorption of the laser beam is facilitated. Therefore, as shown in FIG. 24, performing irradiation at a small pulse repetition frequency in the early stages of the irradiation corresponds to, when forming an affected region functioning as a split originating point, surely causing absorption at a position functioning as the starting point thereof. Therefore, if once the laser beam is surely so absorbed by the split object, the absorption can be continued from then on as in the foregoing embodiments, even by irradiating while scanning a weak laser beam at which no absorption occurs normally in the split object.

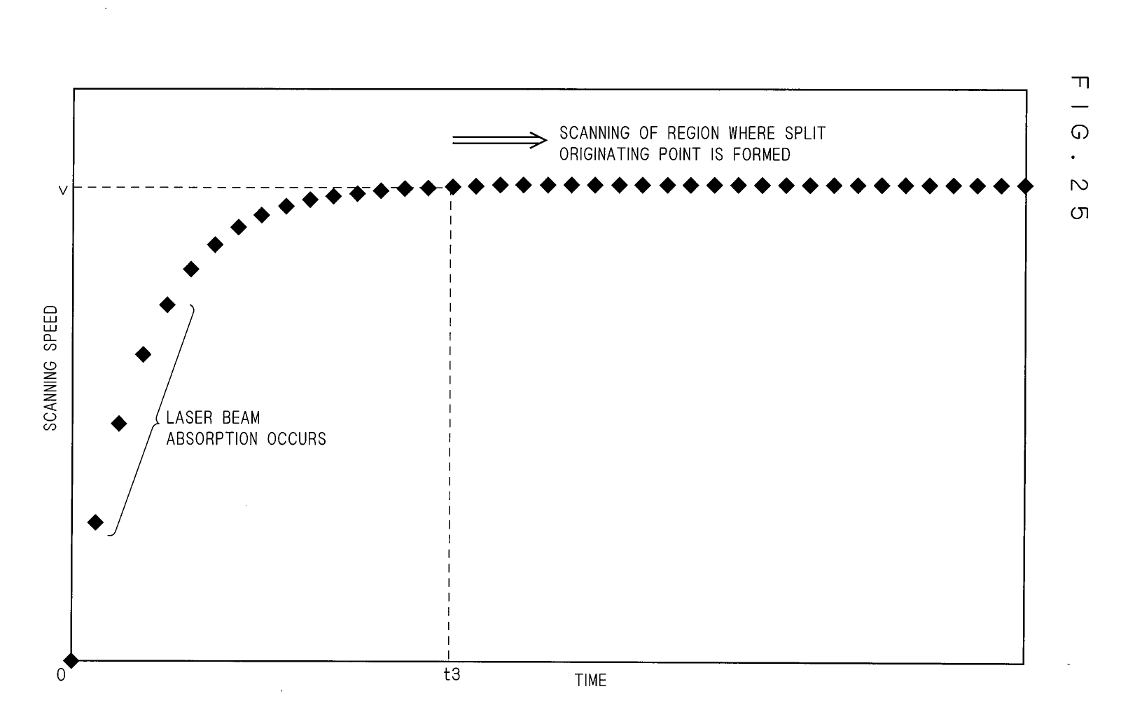

FIG. 25 is a diagram showing a mode of changing the scanning speed of a laser beam. Specifically, using the unnecessary portion of a split object as a starting position, irradiation of a laser beam is started while scanning it at a scanning speed sufficiently smaller than a value v in the steady state, and the scanning speed is then gradually increased so that the speed value is v at the point of time a certain time t3 is elapsed. Then, after the elapse of the time t3 at the latest, the laser beam is adapted to scan at a position at which a split originating point is formed. At this time, the pulse energy value is a value at which no absorption occurs in the split object when the scanning speed is v. If the irradiation power is constant, at a small scanning speed, the energy of the laser beam irradiated at the same location is increased and the absorption of the laser beam is facilitated. Therefore, as shown in FIG. 25, performing irradiation at a small scanning speed in the early stages of the irradiation corresponds to, when forming an affected region functioning as a split originating point, surely causing absorption before the laser beam reaches at a position functioning as the starting point of the region. Therefore, if once the laser beam is surely so absorbed by the split object, the absorption can be continued from then on as in the foregoing embodiments, even by irradiating while scanning a weak laser beam at which no absorption occurs normally in the split object.

Consequently, the case of employing the modes shown in FIG. 24 and FIG. 25 can also perform the formation of the affected region functioning as the split originating point. A specific irradiation condition such as the frequency value f in the steady state, the scanning speed v in the steady state, the times t2, t3, and others can be determined suitably depending on the type of a split object and its surface state, the type of laser, and the like. In FIG. 24 and FIG. 25, although the pulse repetition rate and the scanning speed are expressed as discrete values for the convenience for explanation, in fact, they can be handled as the value changing continuously.

The foregoing respective techniques may be used singly, or combined suitably. For example, while forming a processing line at the outer peripheral part as in the third embodiment, absorption assistance may be supplied to a location functioning as a cut line, as in the second embodiment. Thus, even with a laser beam of weaker pulse energy, an affected region functioning as a split originating point can be surely formed. Which technique is to be employed can be determined suitably depending on the type of a split object, the type of laser, and the like.

Alternatively, as an application of a combination of these techniques, after a laser beam is irradiated to a predetermined position by a certain technique, the laser beam may be irradiated to the same position by using a different technique. Thus, the affected region can be formed in the shape which cannot be attained only by the initial irradiation, and the permissible range of the irradiation condition can be extended.

Further, although in the third embodiment, the location where the laser beam absorption can be carried out surely is created by forming in advance the affected region indicated by the processing line Lt, instead of this, the mode of supplying absorption assistant to a position functioning as a starting point may be used.

The supply of the material acting as the absorption assistant according to the second embodiment may be carried out by a laser processing apparatus having the function thereof, or realized by other techniques or means.

1-26. (canceled)

27. A method of forming a split originating point on a split object, which is a method of forming an originating point for splitting on a split object, comprising:
as an originating point forming step of forming the originating point, an affected region forming step of forming an affected region after having been subjected to melting alteration, from an irradiated surface to an interior in the split object, by irradiating a pulse laser beam of triple harmonics of YAG toward the irradiated surface of the split object, while scanning the pulse laser beam in a predetermined scanning direction in a state where a focal position is held inside the split object, wherein
the affected region forming step is adapted to form the affected region so that a cross section perpendicular to the scanning direction has a lowermost end portion at a position deeper than the focal position, and an interface with an adjacent normal region has a curvature of not greater than zero, by irradiating the pulse laser beam so as to cause energy absorption in a triangular region where the cross section perpendicular to the scanning direction has a base on the irradiated surface and the focal position is a vertex.

28. The method of forming a split originating point according to claim 27, wherein the pulse laser beam is irradiated under an irradiation condition where a part of the split object to which the pulse laser beam is irradiated does not disappear.

29. The method of forming a split originating point according to claim 27, wherein a pulse width of the pulse laser beam is at least 50 nsec.

30. The method of forming a split originating point according to claim 27, further comprising:
a preparatory step, prior to the affected region forming step as the originating point forming step, of performing a predetermined preparatory processing for making sure of absorption of the pulse laser beam in an intended forming location of the originating point in the affected region forming step, wherein
the affected region forming step is adapted to irradiate the pulse laser beam at irradiation energy of strength by which the originating point cannot be formed unless the preparatory step is carried out.

31. The method of forming a split originating point according to claim 30, wherein the preparatory step is a starting point alteration step of forming a starting point affected region at a starting point position of the intended forming location.

32. The method of forming a split originating point according to claim 31, wherein the starting point alteration step is the step of forming the starting point affected region by irradiating a pulse laser beam of triple harmonics of YAG.

33. The method of forming a split originating point according to claim 31, wherein when there exists a plurality of the starting point position, the starting point alteration step is adapted to form the starting point affected region at a plurality of the starting point position.

34. The method of forming a split originating point according to claim 30, wherein the preparatory step is the step of causing absorption of the pulse laser beam at a starting point position in the split object by irradiating the pulse laser beam at larger irradiation energy than in the originating point forming step to a starting point position of the intended forming location, and the preparatory step is shifted to the originating point forming step by starting scanning of the pulse laser beam, while gradually reducing, after the absorption occurs, the irradiation energy to a predetermined steady value.

35. The method of forming a split originating point according to claim 30, wherein the preparatory step is the step of causing absorption of the pulse laser beam at the start point position in the split object by irradiating the pulse laser beam at a smaller pulse repetition rate than in the affected region forming step as the originating point forming step, to the start point position of the intended forming location, and the preparatory step is shifted to the affected region forming step by starting scanning of the pulse laser beam, while gradually increasing, after the absorption occurs, the pulse repetition rate to a predetermined steady value.

36. The method of forming a split originating point according to claim 30, wherein the preparatory step is the step of causing absorption of the pulse laser beam at the starting point position in the split object by irradiating the pulse laser beam at a smaller scanning speed than in the affected region forming step as the originating point forming step, to a starting point position of the intended forming location, and the preparatory step is shifted to the affected region forming step by starting scanning of the pulse laser beam, while gradually increasing, after the absorption occurs, the scanning speed to a predetermined steady value.

37. The method of forming a split originating point according to claim 30, wherein the preparatory step includes a blast treatment step of performing blast treatment to at least a starting point position of the intended forming location.

38. The method of forming a split originating point according to claim 27, wherein the focal position is determined in a range of 10 μm to 30 μm from the irradiated surface.

39. The method of forming a split originating point according to claim 27, wherein the affected region forming step is adapted to form the affected region as a structurally affected region having a crystal state different from that before irradiating the pulse laser beam.

40. The method of forming a split originating point according to claim 39, wherein the split object is a single crystal body of either of a single layer and a multilayer structure, and the affected region is formed as a polycrystalline region.

41. The method of forming a split originating point according to claim 27, wherein the split object is one selected from the group consisting of sapphire, SiC, and a stacked structure using either of them as a base material.

42. The method of forming a split originating point according to claim 27, wherein the affected region forming step is adapted to form the affected region as a low strength region having low dynamic strength than the surroundings thereof.

43. The method of forming a split originating point according to claim 27, wherein circularly polarized light is used as the pulse laser beam.

44. A method of splitting a split object, comprising:
an affected region forming step of forming an affected region after having been subjected to melting alteration, from an irradiated surface of the split object to the inside thereof, by irradiating a pulse laser beam of triple harmonics of YAG toward the irradiated surface of the split object, while scanning the pulse laser beam in a predetermined scanning direction in a state where a focal position is held inside the split object; and
a split step of splitting the split object along the affected region,
wherein
the affected region forming step is adapted to form the affected region so that a cross section perpendicular to the scanning direction has a lowermost end portion at a position deeper than the focal position, and an interface with an adjacent normal region has a curvature of not greater than zero, by irradiating the pulse laser beam so as to cause energy absorption in a triangular region where the cross section perpendicular to the scanning direction has a base on the irradiated surface and the focal position is a vertex.
